(19) United States
(12) Patent Application Publication
(10) Pub. No.: US 2014/0148084 A1
(43) Pub. Date: May 29, 2014

(54) MONEY HANDLING APPARATUS, MONEY HANDLING SYSTEM AND MONEY HANDLING METHOD

(71) Applicants: Yoshiro Oie, Tokyo (JP); Tadashi Urimoto, Tokyo (JP)

(72) Inventors: Yoshiro Oie, Tokyo (JP); Tadashi Urimoto, Tokyo (JP)

(73) Assignee: GLORY LTD., Himeji-Shi, Hyogo-ken (JP)

(21) Appl. No.: 14/233,827

(22) PCT Filed: Jul. 20, 2012
(86) PCT No.: PCT/JP2012/068495

§ 371 Date: Jan. 20, 2014

(30) Foreign Application Priority Data
Jul. 20, 2011 (JP) 2011-158739
Jun. 1, 2012 (JP) 2012-125934

(51) Int. Cl. G07D 1/02

(52) U.S. Cl. CPC G07D 1/02
USPC 453/20

(57) ABSTRACT

A money handling apparatus 100 configured to handle money includes: a selection unit 150 capable of selecting at least an error reset experience mode; and an output unit 152 configured to output information informing that a malfunction has occurred, when the error reset experience mode has been selected by the selection unit 150.

### TECHNICAL FIELD

The present invention relates to a money handling apparatus configured to handle money such as a banknote and a coin, a money handling system including the money handling apparatus, and a money handling method for handling money by means of the money handling apparatus.

### BACKGROUND ART

Various types of money handling apparatuses for handling money, such as a banknote and a coin, have been conventionally known. Specifically, a money change machine formed by integrally combining a banknote change machine and a coin change machine is installed in a store. A clerk deposits a banknote and/or a coin received from a client into the money change machine. In addition, a banknote and/or a coin as change are dispensed from the money change machine.

In such a money change machine, while a banknote/coin depositing process and a banknote/coin dispensing process are performed, a banknote and/or a coin may jam in a machine body to invite a malfunction such as a jam. JP2010-113450A describes that, when a malfunction such as a jam occurs in a machine body, an image of a part to be operated and a restoration operation procedure are displayed stepwise on a display unit, such as a monitor, in accordance with a progress in the restoration operation, in order that an inexpert clerk can perform the restoration operation.

### DISCLOSURE OF THE INVENTION

However, in a conventional money change machine, even when an image of a part to be operated and a restoration operation procedure are displayed stepwise on a display unit, such as a monitor, in accordance with a progress in the restoration operation, an operator who is insufficient in skill may get upset and may not properly deal with a malfunction such as a jam that has occurred in a money handling apparatus. In this case, the on-site operator is likely to ask a maintenance personnel to come to the site, in place of dealing with the malfunction such as a jam by himself/herself. Thus, the money handling apparatus cannot be promptly restored, and a cost is needed to ask a maintenance personnel to come to the site.

In addition to a case in which a banknote or a coin jams in a machine body so that a malfunction such as a jam occurs, when a storage of a money change machine becomes full or empty or when a sensor has a taint, for example, there is a problem in that an operator who is insufficient in skill might get upset because of his/her inexperience and might not promptly restore a money handling apparatus, unless the operator has experienced in advance an error reset operation (restoration operation).

The present invention has been made in view of the above circumstances. The object of the present invention is to provide a money handling apparatus, a money handling system and a money handling method capable of promptly restoring the money handling apparatus regardless of a skill level of an operator, even when a malfunction actually occurs in the money handling apparatus, by causing the operator to experience in advance an error reset operation (restoration operation) outside office hours or the like.

The present invention is a money handling apparatus configured to handle money, the money handling apparatus including: a selection unit capable of selecting at least an error reset experience mode; and an output unit configured to output information informing that a malfunction has occurred, when the error reset experience mode has been selected by the selection unit.

According to such a money handling apparatus, at least the error reset experience mode can be selected by the selection unit. When the error reset experience mode has been selected by the selection unit, information informing that a malfunction has occurred is outputted by the output unit. Namely, by selecting the error reset experience mode by the selection unit, it is possible to cause an operator to experience in advance an error reset operation (restoration operation) outside office hours or the like. As a result, even when a malfunction actually occurs in the money handling apparatus, the money handling apparatus can be promptly restored regardless of a skill level of an operator.

In the money handling apparatus of the present invention, the output unit may be configured to additionally output, when the error reset experience mode has been selected by the selection unit, information relating to a malfunction reset method, in addition to the information informing that a malfunction has occurred.

At this time, the money handling apparatus may further include a judgment unit configured to judge that the malfunction is reset, when the money handling apparatus has been operated in accordance with the information relating to the malfunction reset method outputted by the output unit.

In the money handling apparatus of the present invention, the money handling apparatus may further include a display unit; and the information outputted by the output unit is displayed on the display unit.

At this time, the display unit may be configured to display contents to be displayed when the error reset experience mode has been selected by the selection unit, and contents to be displayed when a mode other than the error reset experience mode has been selected by the selection unit, in different manners from each other.

In the money handling apparatus of the present invention, the money handling apparatus may further include a communication unit; and the information outputted by the output unit may be transmitted by the communication unit to an external apparatus provided separately from the money handling apparatus.

The money handling apparatus of the present invention may further include a transport unit configured to transport money; and a control unit configured to control the transport unit such that the money is stopped in a course of transportation by the transport unit, when the error reset experience mode has been selected by the selection unit.

In the money handling apparatus of the present invention, plural types of the error reset experience modes may be prepared in advance; and when the error reset experience mode has been selected by the selection unit, which type of the error experience mode is to be executed may be also decided.

At this time, the plural types of error reset experience modes may be a part or all of a group including a storage-full reset experience mode, a storage-empty reset experience mode, a sensor-taint reset experience mode, a possible money-amount-error reset experience mode, and a transport-error reset experience mode.

The present invention is a money handling system including: a money handling apparatus configured to handle money; an external apparatus provided separately from the money handling apparatus and connected for communication with the money handling apparatus; wherein the money handling system includes: a selection unit capable of selecting at least an error reset experience mode; and an output unit configured to output information informing that a malfunction has occurred, when the error reset experience mode has been selected by the selection unit.

According to such a money handling system, at least the error reset experience mode can be selected by the selection unit. When the error reset experience mode has been selected by the selection unit, information informing that a malfunction has occurred is outputted by the output unit. Namely, by selecting the error reset experience mode by the selection unit, it is possible to cause an operator to experience in advance an error reset operation (restoration operation) outside office hours or the like. As a result, even when a malfunction actually occurs in the money handling apparatus, the money handling apparatus can be promptly restored regardless of a skill level of an operator.

In the money handling system of the present invention, the external apparatus may include a display unit; and the information outputted by the output unit may be displayed on the display unit.

The present invention is a money handling method for handling money by means of a money handling apparatus, the money handling method including: selecting an error reset experience mode; and outputting information informing that a malfunction has occurred, when the error reset experience mode has been selected.

According to such a money handling method, when the error reset experience mode has been selected, information informing that a malfunction has occurred is outputted. Namely, by selecting the error reset experience mode, it is possible to cause an operator to experience in advance an error reset operation (restoration operation) outside office hours or the like. As a result, even when a malfunction actually occurs in a money handling apparatus, the money handling apparatus can be promptly restored regardless of a skill level of an operator.

The present invention is a money handling apparatus configured to handle money, the money handling apparatus including: a transport unit configured to transport money; and a control unit configured to control the transport unit, upon receipt of a predetermined instruction, such that the money is stopped in a course of transportation by the transport unit.

According to such a money handling apparatus, the control unit is configured to control the transport unit, upon receipt of a predetermined instruction, such that the money is stopped in the course of transportation by the transport unit. Namely, by giving such a predetermined instruction to the control unit, the money is stopped in the course of transportation in a machine body of the money handling apparatus, so that a jam can be artificially generated. Thus, it is possible to cause an operator to experience in advance an error reset operation (restoration operation) outside office hours or the like. As a result, even when a malfunction such as a jam actually occurs in the money handling apparatus, an operator of any skill can promptly restore the money handling apparatus, due to his/her previous experience of the error reset operation (restoration operation of the error reset experience mode).

The present invention is a money handling apparatus configured to handle money, the money handling apparatus including: a transport unit configured to transport money; and a control unit configured to control the transport unit, the control unit provided with a selection unit capable of selecting at least an error reset experience mode, and the control unit configured to control the transport unit such that the money is stopped in a course of transportation by the transport unit, when the error reset experience mode has been selected by the selection unit.

According to such a money handling apparatus, at least the error reset experience mode can be selected by the selection unit. When the error reset experience mode has been selected by the selection unit, the money is stopped in the course of transportation by the transport unit. Namely, by selecting the error reset experience mode by the selection unit, the money is stopped in the course of transportation in a machine body of the money handling apparatus, so that a jam can be artificially generated. Thus, it is possible to cause an operator to experience in advance an error reset operation (restoration operation) outside office hours or the like. As a result, even when a malfunction such as a jam actually occurs in the money handling apparatus, an operator of any skill can promptly restore the money handling apparatus, due to his/her previous experience of the error reset operation (restoration operation of the error reset experience mode).

The money handling apparatus of the present invention may further include an output unit configured to output information informing that a malfunction has occurred, wherein the output unit is configured to output the information informing that a malfunction has occurred, after the money has been stopped in a course of transportation by the transport unit.

At this time, after the money has been stopped in the course of transportation by the transport unit, the output unit may additionally output information relating to a malfunction reset method, in addition to the information informing that a malfunction has occurred.

In addition, the control unit may be provided with a judgment unit configured to judge that a malfunction is reset, when the money handling apparatus has been operated in accordance with the information relating to the malfunction reset method outputted by the output unit.

The present invention is a money handling system including: a money handling apparatus configured to handle money; and an external apparatus provided separately from the money handling apparatus, and connected for communication with the money handling apparatus; wherein the money handling apparatus includes a transport unit configured to transport money; and a control unit configured to control the transport unit, upon receipt of a predetermined instruction, such that the money is stopped in a course of transportation by the transport unit.

According to such a money handling system, the control unit is configured to control the transport unit, upon receipt of a predetermined instruction, such that the money is stopped in the course of transportation by the transport unit. Namely, by giving such a predetermined instruction to the control unit, the money is stopped in the course of transportation in a machine body of the money handling apparatus, so that a jam can be artificially generated. Thus, it is possible to cause an operator to experience in advance an error reset operation (restoration operation) outside office hours or the like. As a result, even when a malfunction such as a jam actually occurs in the money handling apparatus, an operator of any skill can promptly restore the money handling apparatus, due to his/her previous experience of the error reset operation (restoration operation of the error reset experience mode).

The present invention is a money handling system including: a money handling apparatus configured to handle money; and an external apparatus provided separately from the money handling apparatus, and connected for communication with the money handling apparatus; wherein the money handling apparatus includes: a transport unit configured to transport money; and a control unit configured to control the transport unit, the control unit provided with a selection unit capable of selecting at least an error reset experience mode, and the control unit configured to control the transport unit such that the money is stopped in a course of transportation by the transport unit, when the error reset experience mode has been selected by the selection unit.

According to such a money handling system, at least the error reset experience mode can be selected by the selection unit. When the error reset experience mode has been selected by the selection unit, the money is stopped in the course of transportation by the transport unit. Namely, by selecting the error reset experience mode by the selection unit, the money is stopped in the course of transportation in a machine body of the money handling apparatus, so that a jam can be artificially generated. Thus, it is possible to cause an operator to experience in advance an error reset operation (restoration operation) outside office hours or the like. As a result, even when a malfunction such as a jam actually occurs in the money handling apparatus, an operator of any skill can promptly restore the money handling apparatus, due to his/her previous experience of the error reset operation (restoration operation of the error reset experience mode).

The present invention is a money handling method for handling money by means of a money handling apparatus, the money handling method including: transporting money by a transport unit of the money handling apparatus; and stopping the money in a course of transportation by the transport unit upon receipt of a predetermined instruction by a control unit of the money handling apparatus.

According to such a money handling method, the control unit of the money handling apparatus is configured to control the transport unit, upon receipt of a predetermined instruction, such that the money is stopped in the course of transportation by the transport unit. Namely, by giving such a predetermined instruction to the control unit, the money is stopped in the course of transportation in a machine body of the money handling apparatus, so that a jam can be artificially generated. Thus, it is possible to cause an operator to experience in advance an error reset operation (restoration operation) outside office hours or the like. As a result, even when a malfunction such as a jam actually occurs in the money handling apparatus, an operator of any skill can promptly restore the money handling apparatus, due to his/her previous experience of the error reset operation (restoration operation of the error reset experience mode).

The present invention is a money handling method for handling money by means of a money handling apparatus, the money handling method including: transporting money by a transport unit of the money handling apparatus; selecting an error reset experience mode; and stopping the money in a course of transportation by the transport unit when the error reset experience mode has been selected.

According to such a money handling method, when the error reset experience mode has been selected, the money is stopped in the course of transportation by the transport unit. Namely, by selecting the error reset experience mode, the money is stopped in the course of transportation in a machine body of the money handling apparatus, so that a jam can be artificially generated. Thus, it is possible to cause an operator to experience in advance an error reset operation (restoration operation) outside office hours or the like. As a result, even when a malfunction such as a jam actually occurs in the money handling apparatus, an operator of any skill can promptly restore the money handling apparatus, due to his/her previous experience of the error reset operation (restoration operation of the error reset experience mode).

### BRIEF DESCRIPTION OF THE DRAWINGS

FIG. 1 is a schematic structural view schematically showing a structure of a money handling system in one embodiment of the present invention;

FIG. 2 is a perspective view showing appearances of a coin change machine, a banknote change machine and a control terminal machine in the money handling system shown in FIG. 1;

FIG. 3 is a control block diagram of the money handling system shown in FIG. 1 and so on;

FIG. 4 is a flowchart showing an operation performed when an error reset experience mode has been selected in the money handling system shown in FIG. 1 and so on;

FIG. 5 is a view showing contents displayed on an operation display unit when the error reset experience mode has been selected in the money handling system shown in FIG. 1 and so on;

FIG. 6 is a flowchart showing an operation performed when a storage-full reset experience mode has been selected in the money handling system shown in FIG. 1 and so on;

FIG. 7A is a view showing contents displayed on the operation display unit when the storage-full reset experience mode has been selected in the money handling system shown in FIG. 1 and so on;

FIG. 7B is a view showing contents displayed on the operation display unit when the storage-full reset experience mode has been selected in the money handling system shown in FIG. 1 and so on;

FIG. 8 is a flowchart showing an operation performed when a storage-empty reset experience mode has been selected in the money handling system shown in FIG. 1 and so on;

FIG. 9A is a view showing contents displayed on the operation display unit when the storage-empty reset experience mode has been selected in the money handling system shown in FIG. 1 and so on;

FIG. 9B is a view showing contents displayed on the operation display unit when the storage-empty reset experience mode has been selected in the money handling system shown in FIG. 1 and so on;

FIG. 10 is a flowchart showing an operation performed when a sensor-taint reset experience mode has been selected in the money handling system shown in FIG. 1 and so on;

FIG. 11A is a view showing contents displayed on the operation display unit when the sensor-taint reset experience mode has been selected in the money handling system shown in FIG. 1 and so on;

FIG. 11B is a view showing contents displayed on the operation display unit when the sensor-taint reset experience mode has been selected in the money handling system shown in FIG. 1 and so on;

FIG. 12 is a flowchart showing an operation performed when a money-amount-error-dot reset experience mode has been selected in the money handling system shown in FIG. 1 and so on.

FIG. 13A is a view showing contents displayed on the operation display unit when the money-amount-error-dot reset experience mode has been selected in the money handling system shown in FIG. 1 and so on;

FIG. 13B is a view showing contents displayed on the operation display unit when the money-amount-error-dot reset experience mode has been selected in the money handling system shown in FIG. 1 and so on;

FIG. 14 is a flowchart showing an operation performed when a transport-error reset experience mode has been selected in the money handling system shown in FIG. 1 and so on;

FIG. 15 is a view showing contents displayed on the operation display unit when the transport-error reset experience mode has been selected in the money handling system shown in FIG. 1 and so on; and

FIG. 16 is a flowchart showing operations of the coin change machine and the banknote change machine in a modification example.

### MODE FOR CARRYING OUT THE INVENTION

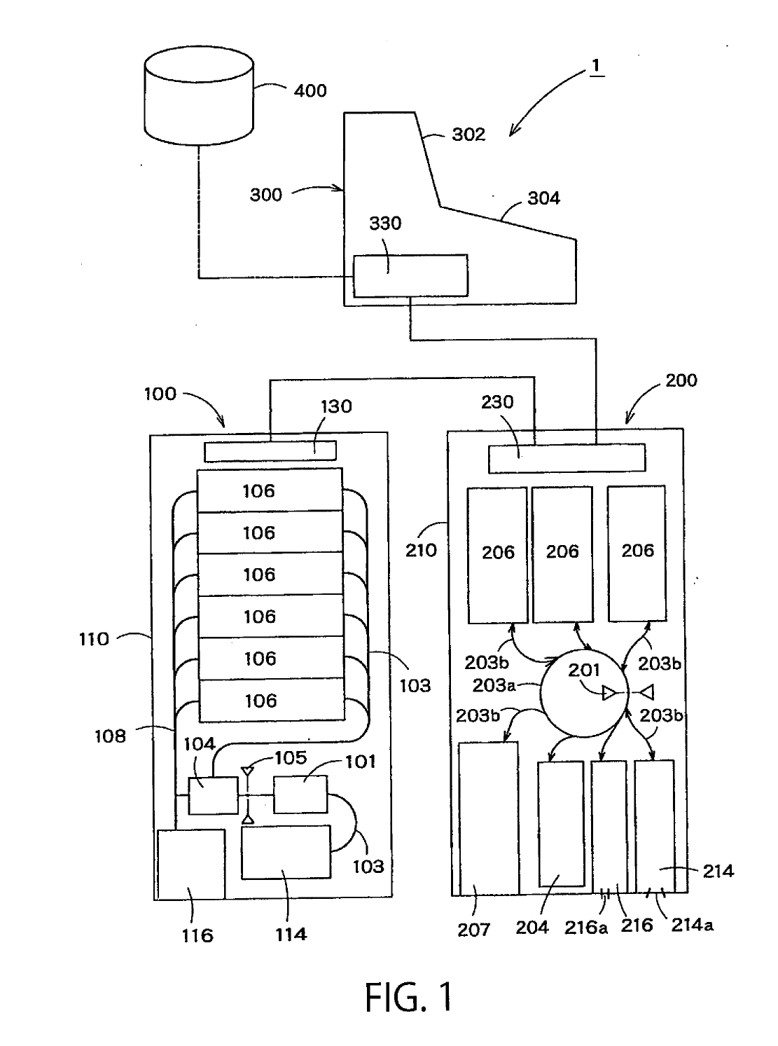

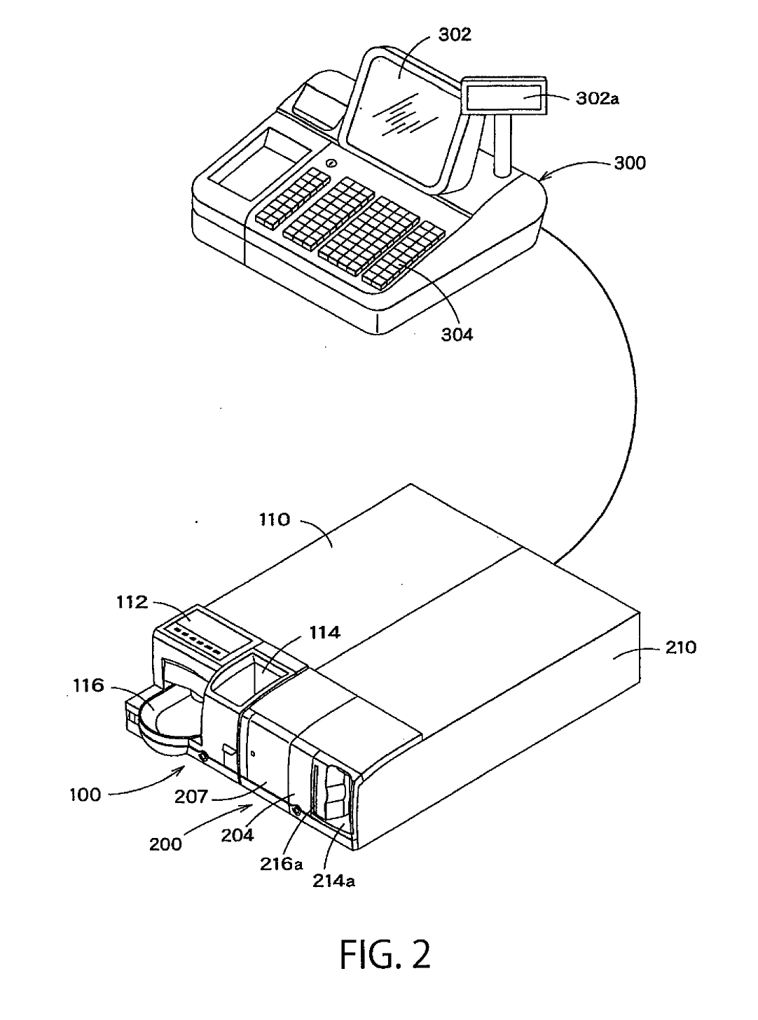

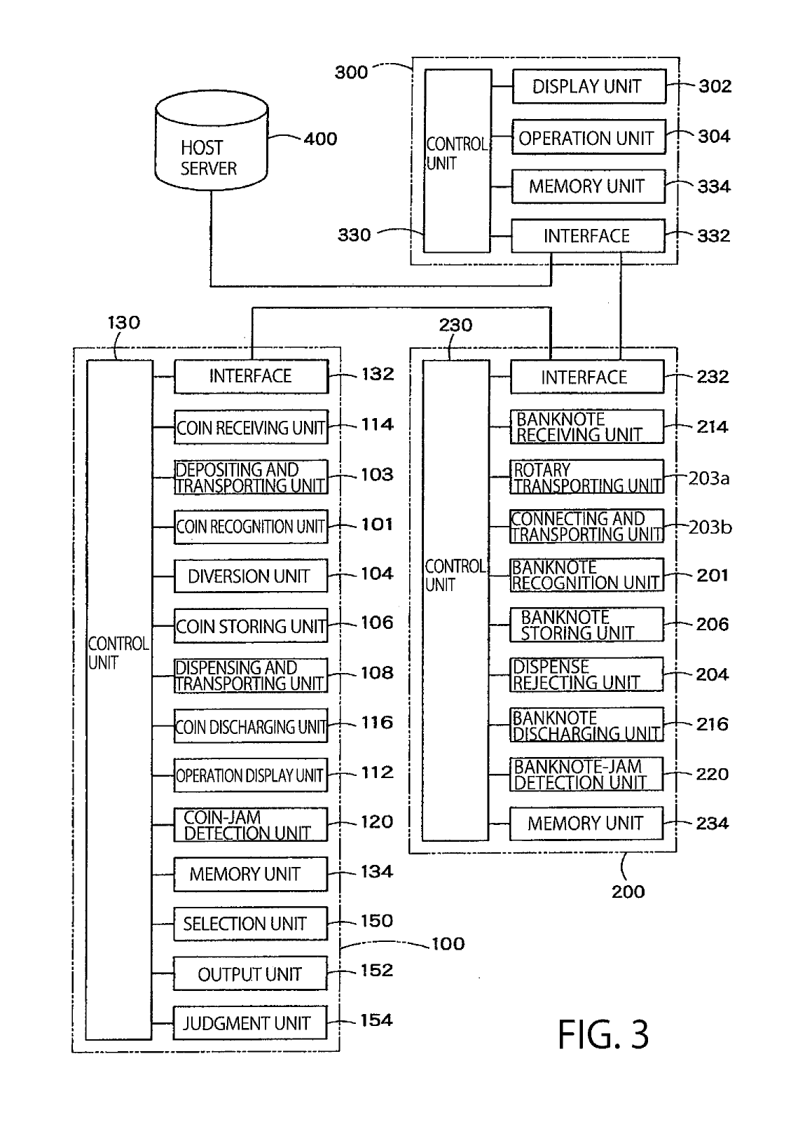

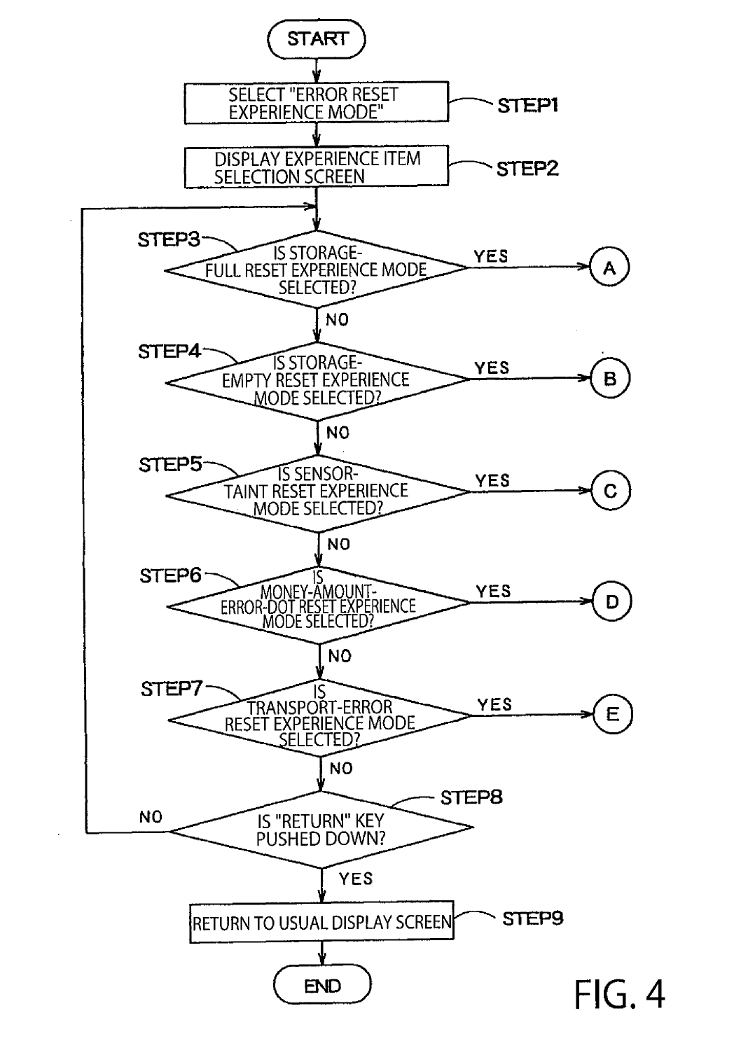

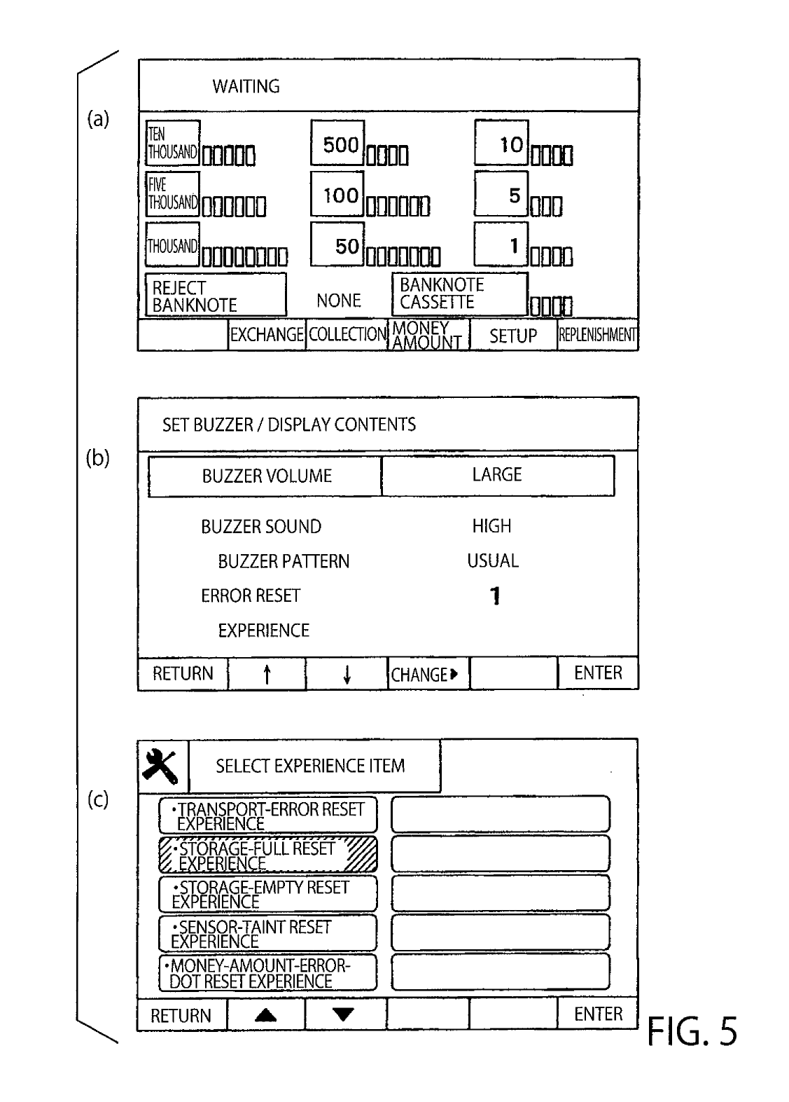

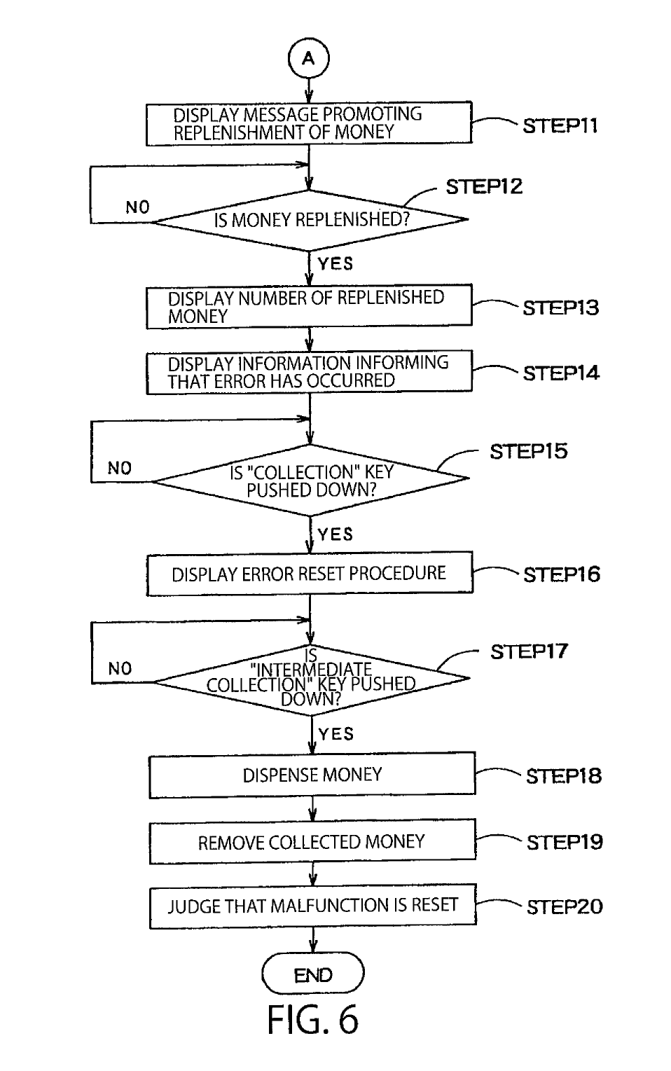

An embodiment of the present invention will be described herebelow with reference to the drawings. FIGS. 1 to 15 are views showing a structure of a money handling system according to this embodiment. FIG. 1 is a schematic structural view schematically showing a structure of the money handling system in this embodiment. FIG. 2 is a perspective view showing appearances of a coin change machine, a banknote change machine and a control terminal machine in the money handling system shown in FIG. 1. FIG. 3 is a control block diagram of the money handling system shown in FIG. 1 and so on. FIG. 4 is a flowchart showing an operation performed when an error reset experience mode has been selected in the money handling system shown in FIG. 1 and so on. FIG. 5 is a view showing contents displayed on an operation display unit when the error reset experience mode has been selected in the money handling system shown in FIG. 1 and so on. FIGS. 6 to 15 are flowcharts showing operations performed when various types of error reset experience modes have been selected, and views showing contents displayed on an operation display unit.

An overall structure of the money handling system is firstly described with reference to FIGS. 1 and 2. As shown in FIGS. 1 and 2, the money handling system 1 includes a coin change machine 100, a banknote change machine 200 and a control terminal machine 300. The coin change machine 100 and the banknote change machine 200 are configured to perform a coin depositing/dispensing operation and a banknote depositing/dispensing operation, respectively. More specifically, a coin and a banknote from a client are respectively deposited into the coin change machine 100 and the banknote change machine 200, and a coin and a banknote as change are respectively dispensed from the coin change machine 100 and the banknote change machine 200. In addition, as shown in FIG. 2, the coin change machine 100 and the banknote change machine 200 are juxtaposed in a right and left direction.

On the other hand, the control terminal machine 300 is formed of, e.g., a POS register (money registration machine having a point of sale function). The control terminal machine 300 is connected for communication with a host server 400. Sales information and the like is transmitted from the control terminal machine 300 to the host server 400.

As shown in FIG. 1, the coin change machine 100 and the banknote change machine 200 include control units 130 and 230, respectively. These control units 130 and 230 are connected for communication with each other. In addition, the control terminal machine 300 includes a control unit 330. The control unit 230 of the banknote change machine 200 is connected for communication with the control unit 330 of the control terminal machine 300. The control terminal machine 300 is placed on upper surfaces of the coin change machine 100 and the banknote change machine 200.

Herebelow, the coin change machine 100, the banknote change machine 200 and the control terminal machine 300 are described in detail with reference to FIGS. 1 and 2.

Firstly, a structure of the coin change machine 100 is concretely described. As shown in FIGS. 1 and 2, the coin change machine 100 includes a housing 110 that has an operation display unit 112, such as a touch panel, on a front upper surface thereof. A coin receiving unit 114 and a coin discharging unit 116 are disposed on the front part of the housing 110.

The coin receiving unit 114 is configured to take in a received coin(s) one by one, in such a manner that the coins are aligned in a not-overlapped state. A depositing and transporting unit 103, which is configured to transport a coin having been taken into the machine by the coin receiving unit 114, is connected to the coin receiving unit 114.

The depositing and transporting unit 103 is provided with a coin recognition unit 101 configured to recognize a coin, and a diversion unit 104, respectively. The diversion unit 104 is configured to guide (transport) a coin to be discharged from the coin discharging unit 116, such as a reject coin, to a dispensing and transporting unit 108, based on a coin recognition result by the coin recognition unit 101.

On the other hand, a coin to be stored into the machine, such as a normal coin, is transported by the depositing and transporting unit 103 to any of coin storing units 106. The coin storing units 106 are configured to store coins by denomination. To be specific, the coins are stored from an upstream side of the depositing and transporting unit 103 in a descending order of denomination, for example.

The dispensing and transporting unit 108 is configured to transport a coin, which has been fed out from the coin storing units 106, to the coin discharging unit 116. In addition, the dispensing and transporting unit 108 is configured to transport a reject coin and the like, which has been guided from the diversion unit 104, to the coin discharging unit 116.

Next, a structure of the banknote change machine 200 is concretely described. As shown in FIGS. 1 and 2, the banknote change machine 200 includes a housing 210 and an annular rotary transporting unit 203a disposed at substantially a central part in the housing 210. A banknote receiving unit 214, three banknote storing units 206, a banknote discharging unit 216, a dispense rejecting unit 204 and a banknote collecting cassette 207 are located to surround the rotary transporting unit 203a from outside.

Inside the housing 210 of the banknote change machine 200, there are formed a plurality of connecting and transporting units 203b which connect the banknote receiving unit 214 and the rotary transporting unit 203a, the respective banknote storing units 206 and the rotary transporting unit 203a, the banknote discharging unit 216 and the rotary transporting unit 203a, the dispense rejecting unit 204 and the rotary transporting unit 203a, and the banknote collecting cassette 207 and the rotary transporting unit 203a, respectively. The rotary transporting unit 203a is provided with a banknote recognition unit 201. The banknote recognition unit 201 is configured to recognize a banknote passing through the banknote recognition unit 201.

In addition, a route switching unit (not shown), which is configured to switch banknote transporting routes between the rotary transporting unit 203a and the respective connecting and transporting units 203b, is disposed along the rotary transporting unit 203a.

As shown in FIGS. 1 and 2, a front surface of the housing 210 has a banknote inlet 214a of the banknote receiving unit 214 and a banknote outlet 216a of the banknote discharging unit 216, respectively. The banknote collecting cassette 207 is detachably attached to the housing 210.

The banknote receiving unit 214 is configured to take in, one by one, a deposited banknote(s) inserted into the banknote inlet 214a, and to feed the banknotes toward the rotary transporting unit 203a. The respective banknote storing units 206 are configured to store the banknotes by denomination, based on a recognition result of the banknote recognition unit 201. The banknote discharging unit 216 is configured to dispense a banknote, which has been fed out from each of the banknote storing units 206 to the rotary transporting unit 203a, to the outside of the machine through the banknote outlet 216a.

Among the banknotes having been fed out from the banknote storing units 206, the dispense rejecting unit 204 is configured to store a banknote that could not be recognized by the banknote recognition unit 201 because of a skewed state thereof or the like, as a dispense reject banknote. In addition, among the banknotes having been taken into the machine through the banknote receiving unit 214, a banknote that could not be recognized by the banknote recognition unit 201 because of a stain thereof or the like, is returned as a deposit reject banknote to the banknote discharging unit 216.

Next, a structure of the control terminal machine 300 is concretely described. As described above, the control terminal machine 300 is formed of, e.g., a POS register (money registration machine having a point of sale function). The control terminal machine 300 is configured to register article purchase information, and to cause the coin change machine 100 and the banknote change machine 200 to perform a coin depositing/dispensing operation and a banknote depositing/dispensing operation, respectively.

As shown in FIG. 1, the control unit 330 of the control terminal machine 300 is connected for communication with the control unit 230 of the banknote change machine 200, and is also connected for communication with the host server 400. The control unit 330 is configured to cause the coin change machine 100 and the banknote change machine 200 to perform a coin depositing/dispensing operation and a banknote depositing/dispensing operation, by transmitting commands to the control unit 130 of the coin change machine 100 and the control unit 230 of the banknote change machine 200. In addition, the control unit 330 is configured to receive, from the control unit 130 of the coin change machine 100 and the control unit 230 of the banknote change machine 200, information relating to a coin handling condition in the coin change machine 100 and information relating to a banknote handling condition in the banknote change machine 200.

An operation unit 304 can be operated by an operator, in such a manner that various commands can be given to the control unit 330. A display unit 302 is configured to display the coin handling condition in the coin change machine 100 and the banknote handling condition in the banknote change machine 200, and money amounts of coins and banknotes stored inside the coin change machine 100 and the banknote change machine 200. In addition, the control terminal machine 300 is provided with an additional display unit 302a. The additional display unit 302a may be configured to display various information, instead of the display unit 302, or in addition to the display unit 302.

FIG. 3 shows a control block diagram of the money handling system 1 as structured above. As shown in FIG. 3, connected to the control unit 130 of the coin change machine 100 are an interface 132, the coin receiving unit 114, the depositing and transporting unit 103, the coin recognition unit 101, the diversion unit 104, the coin storing units 106, the dispensing and transporting unit 108, the coin discharging unit 116, the operation display unit 112 and a memory unit 134, respectively. A coin recognition result is transmitted from the coin recognition unit 101 to the control unit 130, and various commands are transmitted from the control unit 130 to the coin receiving unit 114, the depositing and transporting unit 103, the diversion unit 104, the coin storing units 106, the dispensing and transporting unit 108 and the coin discharging unit 116 and so on, respectively. The control unit 130 of the coin change machine 100 is configured to transmit and receive a signal to and from the control unit 230 of the banknote change machine 200 through the interface 132. In addition, the operation display unit 112 is configured to transmit a command having been inputted by an operator to the operation display unit 112, to the control unit 130, and the control unit 130 is configured to transmit a command to the operation display unit 112 so as to cause the operation display unit 112 to display various information. In more detail, the operation display unit 112 is configured to display the coin handling condition and the banknote handling condition in the coin change machine 100 and the banknote change machine 200, and the money amounts of coins and banknotes stored inside the coin change machine 100 and the banknote change machine 200. The memory unit 134 is configured to store various information such as setting contents and so on.

In addition, as shown in FIG. 3, the coin change machine 100 is provided with a coin-jam detection unit 120. The coin-jam detection unit 120 is connected to the control unit 130. When a coin jams in the depositing and transporting unit 103 of the coin change machine 100, or the dispensing and transporting unit 108 thereof, or the like, the coin-jam detection unit 120 is configured to detect that the coin jams. When the coin-jam detection unit 120 detects that the coin jams, such information is transmitted to the control unit 130.

In addition, as shown in FIG. 3, connected to the control unit 130 of the coin change machine 100 are a selection unit 150, an output unit 152 and a judgment unit 154, respectively. The selection unit 150 is configured to be capable of selecting at least an error reset experience mode. The output unit 152 is configured to output, when the error reset experience mode has been selected by the selection unit 150, information informing that a malfunction has occurred. In addition, the output unit 152 may be configured to additionally output, when the error reset experience mode has been selected by the selection unit 150, information relating to a malfunction reset method, in addition to the information informing that a malfunction has occurred. The information outputted by the output unit 152 is displayed on the operation display unit 112 of the coin change machine 100, or is transmitted through the interface 132 to the control unit 230 of the banknote change machine 200, the control unit 330 of the control terminal machine 300, or the host server 400. When the information outputted by the output unit 152 is transmitted to the control unit 330 of the control terminal machine 300, the information can be displayed on the display unit 302 of the control terminal machine 300. Thus, an error reset operation can be performed by using the large display unit of the control terminal machine 300. In addition, if a printer is connected to the control terminal machine 300, when the information outputted by the output unit 152 is transmitted to the control unit 330 of the control terminal machine 300, the information outputted by the output unit 152 can be printed by the printer. The judgment unit 154 is configured to judge that the malfunction is reset, when the coin change machine 100 and/or the banknote change machine 200 have been operated in accordance with the information relating to the malfunction reset method outputted by the output unit 152.

In addition, connected to the control unit 230 of the banknote change machine 200 are an interface 232, the banknote receiving unit 214, the rotary transporting unit 203a, the connecting and transporting units 203b, the banknote recognition unit 201, the banknote storing units 206, the dispensing and rejection unit 204, the banknote discharging unit 216 and a memory unit 234 and so on, respectively. A banknote recognition result is transmitted from the banknote recognition unit 201 to the control unit 230, and various commands are transmitted from the control unit 230 to the banknote receiving unit 214, the rotary transporting unit 203a, the connecting and transporting units 203b, the banknote storing units 206, the dispense rejecting unit 204, the banknote discharging unit 216 and so on, respectively. The control unit 230 of the banknote change machine 200 is configured to transmit and receive a signal, through the interface 232, to and from the control unit 130 of the coin change machine 100 and to and from the control unit 330 of the control terminal machine 300.

In addition, as shown in FIG. 3, the banknote change machine 200 is provided with a banknote-jam detection unit 220. The banknote-jam detection unit 220 is connected to the control unit 230. When a banknote jams in the rotary transporting unit 203a of the banknote change machine 200, or the connecting and transporting units 203b thereof, or the like, the banknote-jam detection unit 220 is configured to detect that the banknote jams. When the banknote-jam detection unit 220 detects that the banknote jams, such information is transmitted to the control unit 230.

In addition, connected to the control unit 330 of the control terminal machine 300 are the display unit 302, the operation unit 304, a memory unit 334, an interface 332 and so on, respectively. The operation unit 304 is configured to transmit a command having been inputted by an operator to the operation unit 304, to the control unit 330, and the control unit 330 is configured to transmit a command to the display unit 302 so as to cause the display unit 302 to display various information. The control unit 330 may cause the additional display unit 302a to display various information, instead of the display unit 302, or in addition to the display unit 302. Further, the control unit 330 of the control terminal machine 300 is configured to transmit and receive a signal, through the interface 332, to and from the control unit 230 of the banknote change machine 200 and to and from the host server 400.

Next, an operation of the money handling system 1 as structured above is described. The below-described operation of the banknote handling system 1 is performed by the control unit 130 of the coin change machine 100, which controls the respective constituent elements of the coin change machine 100, and by the control unit 230 of the banknote change machine 200, which controls the respective constituent elements of the banknote change machine 200. In the money handling system 1 in this embodiment, each of the control unit 130 of the coin change machine 100 and the control unit 230 of the banknote change machine 200 is configured to selectively perform any one of a usual mode and an error reset experience mode. When a power starts to be applied to the coin change machine 100 and the banknote change machine 200 (when the coin change machine 100 and the banknote change machine 200 are turned ON), the control unit 130 and control unit 230 are configured to start up in the usual mode.

The operation of the money handling system 1 is described in more detail. Usually, the control unit 130 of the coin change machine 100 and the control unit 230 of the banknote change machine 200 execute the usual mode. In this case, when a coin(s) is received in the coin receiving unit 114 of the coin change machine 100, the coin receiving unit 114 takes the coins one by one into the machine, in such a manner that the coins are aligned in a not-overlapped state. The taken-in coins are transported by the depositing and transporting unit 103. The coin transported by the deposing and transporting unit 103 is recognized by the coin recognition unit 101. A coin, which has been recognized as a coin to be discharged from the coin discharging unit 116 based on a coin recognition result by the coin recognition unit 101, such as a reject coin or the like, is guided (transported) by the diversion unit 104 to the dispensing and transporting unit 108. Then, the coin is transported by the dispensing and transporting unit 108 to the coin discharging unit 116. On the other hand, a coin, which has been recognized as a coin to be stored into the machine based on a coin recognition result by the coin recognition unit 101, such as a normal coin or the like, is transported by the depositing and transporting unit 103 to the coin storing units 106, and is stored into the coin storing units 106 by denomination.

In order that a coin(s) is dispensed as change from the coin change machine 100 while the usual mode is in execution by the control unit 130 of the coin change machine 100, an operator inputs the number and/or a total sum of coins to be dispensed by denomination through the operation display unit 112. Alternatively, a dispensing command is transmitted from the control unit 330 of the control terminal machine 300 to the control unit 130 of the coin change machine 100, so that a coin as change is dispensed from the coin change machine 100. When the dispensing command is given to the control unit 130 of the coin change machine 100, a coin stored in the coin storing units 106 is fed out from the coin storing units 106, and the fed-out coin is transported by the dispensing and transporting unit 108 to the coin discharging unit 116. In this manner, the operator can take out the coin from the coin discharging unit 116.

On the other hand, when a banknote(s) is inserted into the banknote inlet 214a of the banknote receiving unit 214 while the usual mode is in execution by the control unit 230 of the banknote change machine 200, the banknote receiving unit 214 takes in the machine the banknotes to be deposited inserted into the banknote inlet 214a, one by one, and feeds out the banknotes toward the rotary transporting unit 203a. The banknotes having been fed out toward the rotary transporting unit 203a are transported by the rotary transporting unit 203a. At this time, the banknotes are recognized by the banknote recognition unit 201. A banknote having been recognized as a normal banknote by the banknote recognition unit 201 is stored into each of the banknote storing units 206 by denomination. On the other hand, among the banknotes having been taken in from the banknote receiving unit 214, a banknote that could not be recognized by the banknote recognition unit 201 because of a stain thereof or the like is returned to the banknote discharging unit 216, as a deposit reject banknote.

In addition, in order that a banknote(s) is dispensed as change from the banknote change machine 200 while the usual mode is in execution by the control unit 230 of the banknote change machine 200, so that an operator inputs the number and/or a total sum of banknotes to be dispensed by denomination through the operation display unit 112. Alternatively, a dispensing command is transmitted form the control unit 330 of the control terminal machine 300 to the control unit 230 of the banknote change machine 200, so that a banknote as change is dispensed from the banknote change machine 200. When the dispensing command is given to the control unit 230 of the banknote change machine 200, a banknote stored in the banknote storing units 206 is fed out from the banknote storing units 206, and the fed-out banknote is recognized by the recognition unit 201. Thereafter, the banknote is sent by the rotary transporting unit 203a to the banknote discharging unit 216. Then, the banknote discharging unit 216 discharges the banknote having been sent from the banknote storing units 206 to the outside of the housing 210 through the banknote outlet 216a. In this manner, the operator can obtain the banknote dispensed from the banknote change machine 200. Among the banknotes fed out from the banknote storing units 206, a banknote that could not be recognized by the banknote recognition unit 201 because of a skewed state thereof or the like is stored into the dispense rejecting unit 204, as a dispense reject banknote.

While the usual mode is in execution by the control unit 130 of the coin change machine 100 and the control unit 230 of the banknote change machine 200, when an error such as a jam occurs in the coin change machine 100 and the banknote change machine 200, e.g., when the coin-jam detection unit 120 detects that a coin jams in the depositing and transporting unit 103, or the dispensing and transporting unit 108, or the like, and/or when the banknote-jam detection unit 220 detects that a banknote jams in the rotary transporting unit 203a and/or the connecting and transporting units 203b, information informing that an error has occurred and information relating to an error reset method are displayed on the operation display unit 121. In more detail, an image of a part to be operated for resetting the error and a restoration operation procedure are displayed on the operation display unit 112. Then, while looking at the error reset method displayed on the operation display unit 112, the operator performs an error reset operation (restoration operation) by removing a coin and/or a banknote causing the jam inside the coin change machine 100 and/or the banknote change machine 200.

Next, a method of switching a handling mode from the usual mode to the error reset experience mode in the control unit 130 of the coin change machine 100 and the control unit 230 of the banknote change machine 200 is described below with reference to the flowchart shown in FIG. 4 and a display screen of the operation display unit 112 of the coin change machine 100 shown in FIG. 5.

FIG. 5(a) shows a ready and waiting screen of the operation display unit 112 of the coin change machine 100 in the usual mode. While the ready and waiting screen shown in FIG. 5(a) is displayed on the operation display unit 112, when an operator pushes down a “setup” key, the display screen of the operation display unit 112 is switched to a setup screen shown in FIG. 5(b). Then, while the setup screen shown in FIG. 5(b) is displayed on the operation display unit 112, the operator applies a cursor to “error reset experience” and pushes down an “enter” key. In this case, as shown in a STEP 1 of the flowchart shown in FIG. 4, the error reset experience mode is selected by the selection unit 150, so that the display screen of the operation display unit 112 switches to a screen shown in FIG. 5(c), by which an experience item of the error reset experience can be selected (STEP 2). As shown in FIG. 5(c), plural types of error reset experience modes are prepared. When one of the error reset experience modes is selected by the selection unit 150, which type of the error reset experience mode is to be executed is also selected. To be specific, five error reset experience modes are prepared. Namely, there are prepared a transport-error reset experience mode, a storage-full reset experience mode, a store-empty reset experience mode, a sensor-taint reset experience mode and a money-amount-error-dot reset experience mode (a possible money-amount-error reset experience mode). Note that it is not necessary to prepare all the above five error reset experience modes, and that only a part of these five error reset experience modes may be prepared.

As shown in the flowchart of FIG. 4, when the operator selects the storage-full reset experience mode (“YES” in STEP 3), the below-described storage-full reset experience mode is executed. The storage-full reset experience mode relates to a method for causing an operator to experience in advance an error reset operation that is to be performed when the coin storage unit 106 of the coin change machine 100 and/or any of the banknote storing units 206 of the banknote change machine 200 become a full state or a near-full state.

Alternatively, when the operator selects the storage-empty reset experience mode (“YES” in STEP 4), the below-described storage-empty reset experience mode is executed. The storage-empty reset experience mode relates to a method for causing an operator to experience in advance an error reset operation that is to be performed when the coin storage unit 106 of the coin change machine 100 and/or any of the banknote storing units 206 of the banknote change machine 200 become an empty state or a near-empty state.

Alternatively, when the operator selects the sensor-taint reset experience mode (“YES” in STEP 5), the below-described sensor-taint reset experience mode is executed. The sensor-taint reset experience mode relates to a method for causing an operator to experience in advance an error reset operation that is to be performed when various sensors disposed in the coin change machine 100 and the banknote change machine 200 have a taint.

Alternatively, when the operator selects the money-amount-error-dot reset experience mode (“YES” in STEP 6), the below-described money-amount-error-dot reset experience mode is executed. The money-amount-error-dot reset experience mode relates to a method for causing an operator to experience in advance an operation that is to be performed when a money amount of coins stored in the respective coin storage units 106 of the coin change machine 100 and/or a money amount of banknotes stored in the respective banknote storing units 206 of the banknote change machine 200 are possibly in error, so as to eliminate such an error possibility. The “possibility that a money amount of coins stored in the respective coin storage units 106 of the coin change machine 100 or a money amount of banknotes stored in the respective banknote storing units 206 of the banknote change machine 200 is in error” may be caused when two or more coins are simultaneously fed out in the coin change machine 100 or two or more banknotes are simultaneously fed out in the banknote change machine 200. In this case, actual coin/banknote handling contents in the coin change machine 100 and the banknote change machine 200 differ from coin/banknote handling contents to be managed by the control units 130 and 230, which results in a money-amount-error-dot.

Alternatively, when the operator selects the transport-error reset experience mode (“YES” in STEP 7), the below-described transport-error reset experience mode is executed. The transport-error reset experience mode relates to a method for causing an operator to experience in advance an error reset operation that is to be performed when a coin or a banknote jams in the depositing and transporting unit 103 of the coin change machine 100, or the rotary transporting unit 203a of the banknote change machine 200, or the like.

While the selection screen of the error reset experience items shown in FIG. 5(c) is displayed on the operation display unit 112, when the operator pushes down a “return” key (“YES” in STEP 8), the display screen of the operation display unit 112 returns to the setup screen shown in FIG. 5(b). Thus, it is possible to reset the error reset experience mode so as to return to the usual mode (STEP 9). On the other hand, while the setup screen shown in FIG. 5(b) is displayed on the operation display unit 112, when the operator pushes down the “return” key, the display screen of the operation display unit 112 returns to the ready and waiting screen shown in FIG. 5(a).

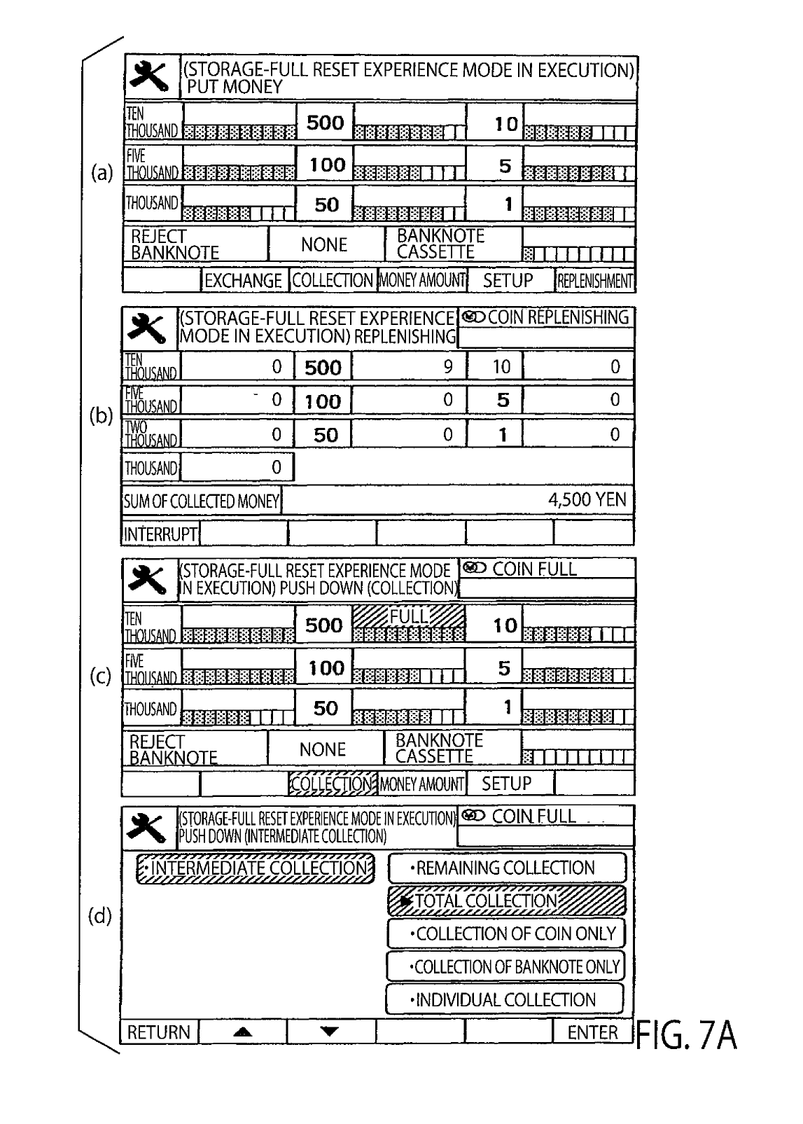

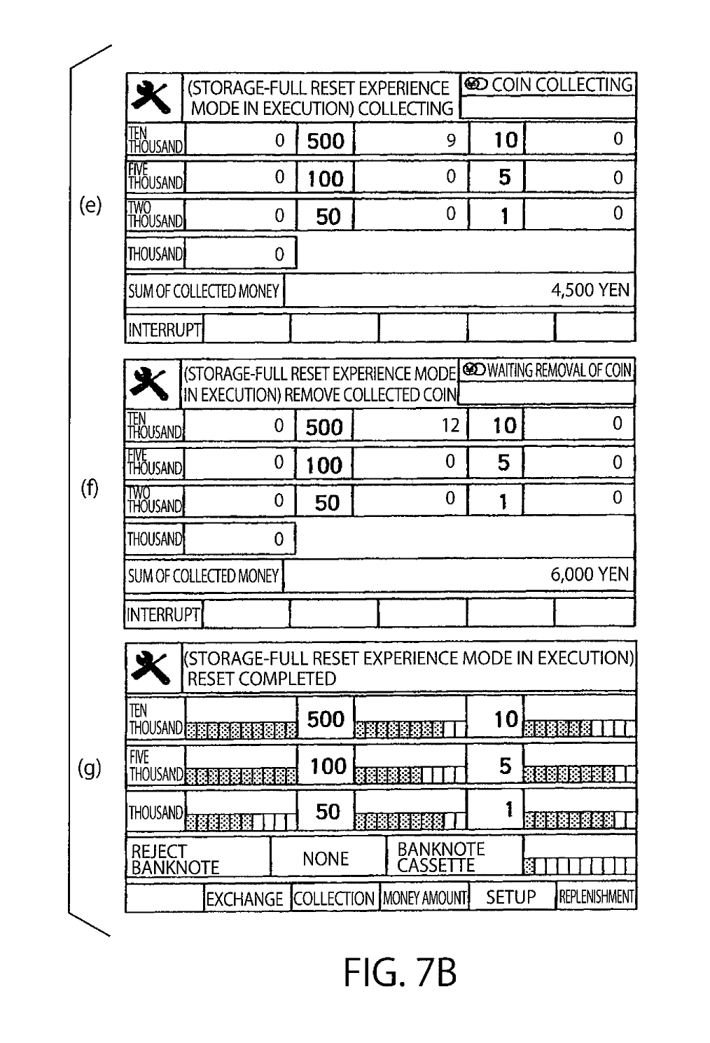

Next, there is described an operation that is performed when the storage-full reset experience mode is in execution by the control unit 130 of the coin change machine 100 and the control unit 230 of the banknote change machine 200, with reference to the flowchart shown in FIG. 6 and the display screen of the operation display unit 112 of the coin change machine 100 shown in FIGS. 7A and 7B.

While the experience item selection screen of the error reset experience mode shown in FIG. 5(c) is displayed on the operation display unit 112, when the storage-full reset experience mode is selected by the selection unit 150 (“YES” in STEP 3), as shown in FIG. 7A(a), a message promoting replenishment of coins is firstly displayed on the operation display unit 112 (STEP 11). Then, when coins have been replenished into the coin change machine 100 (“YES” in STEP 12), as shown in FIG. 7A(b), the number of replenished coins is displayed on the operation display unit 112 (STEP 13). At this time, even when only one coin is replenished by the operator into the coin change machine 100, a coin-full is detected in the control unit 130. Thus, it is not necessary for the operator to further replenish a coin into the coin change machine 100.

Then, as shown in FIG. 7A(c), an error relating to the storage-full is displayed on the operation display unit 112 (STEP 14). Specifically, a message of “coin full” and information informing that which denomination of coins is in the full state are displayed on the operation display unit 112. In addition, as shown in FIG. 7A(c), a message of “push down collection key” is displayed on the operation display unit 112. At this time, the “collection” key is highlighted on the operation display unit 112.

When the operator has pushed down the “collection” key (“YES” in STEP 15), as shown in FIG. 7A(d), an error reset procedure is displayed on the operation display unit 112 (STEP 16). To be specific, as a method for resetting the malfunction of storage-full, there is used a method in which an “intermediate collection” key is pushed down so that coins in the coin storing unit 106 are dispensed from the coin change machine 100 so as to be collected. In order thereto, a message of “push down intermediate collection key” is displayed on the operation display unit 112. At this time, the “intermediate collection” key is highlighted on the operation display unit 112.

When the operator has pushed down the “intermediate collection” key (“YES” in STEP 17), a dispensing operation is performed in the coin change machine 100 (STEP 18). At this time, as shown in FIG. 7B(e), a message of “collecting” is displayed on the operation display unit 112. When the coin collection operation in the coin change machine 100 has been finished, as shown in FIG. 7B(f), a message of “pull out collected coin” is displayed on the operation display unit 112. Thereafter, when the operator has pulled out the collected coins (STEP 19), the judgment unit 154 judges that the malfunction is reset (STEP 20). Then, as shown in FIG. 7B(g), a message of “reset completed” is displayed on the operation display unit 112. In this manner, the storage-full reset experience mode is completed.

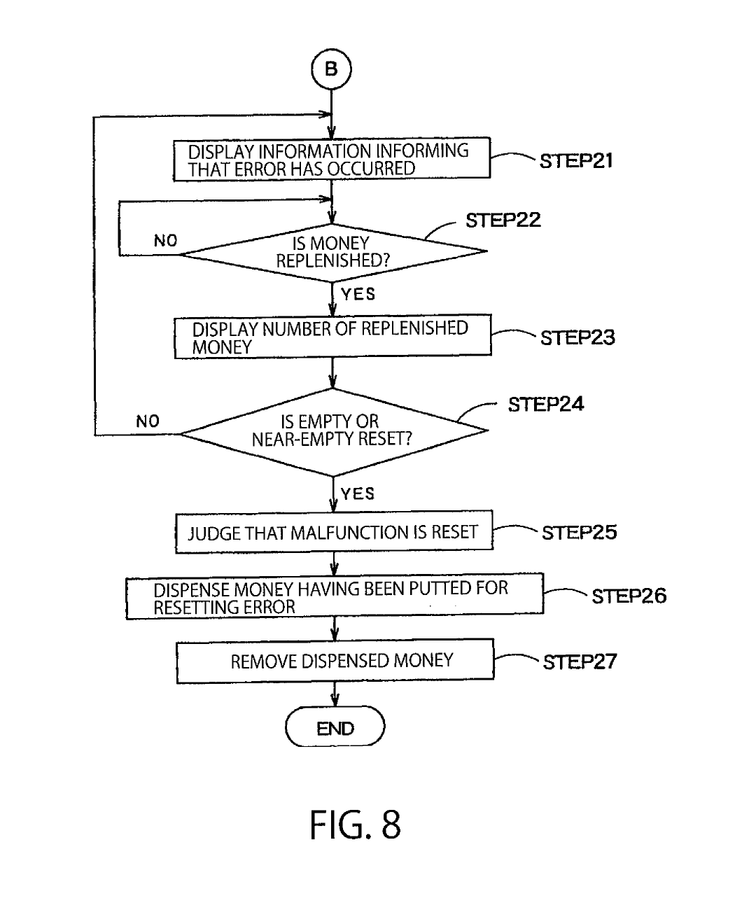

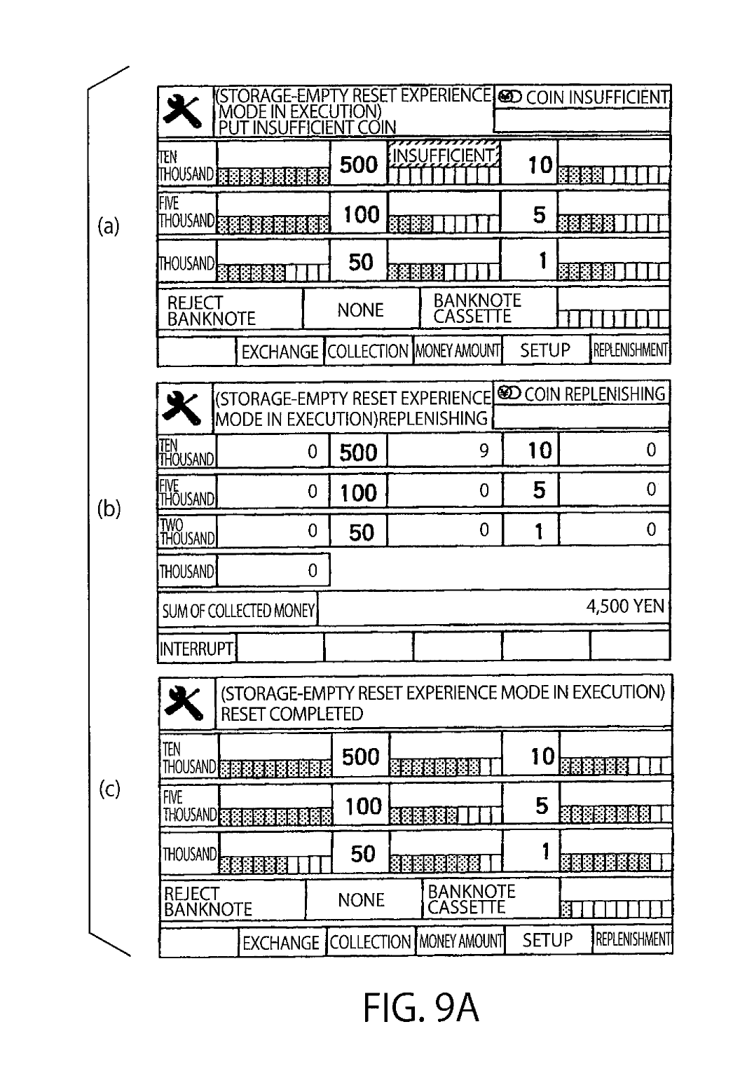

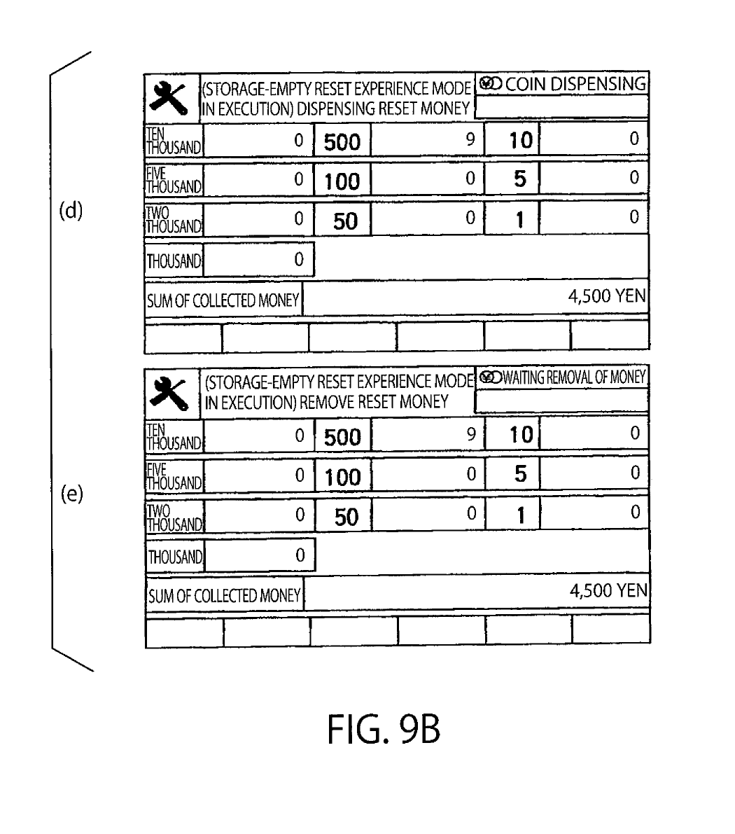

Next, there is described an operation that is performed when the storage-empty reset experience mode is in execution by the control unit 130 of the coin change machine 100 and the control unit 230 of the banknote change machine 200, with reference to the flowchart shown in FIG. 8 and the display screen of the operation display unit 112 of the coin change machine 100 shown in FIGS. 9A and 9B.

While the experience item selection screen of the error reset experience mode shown in FIG. 5(c) is displayed on the operation display unit 112, when the storage-empty reset experience mode is selected by the selection unit 150 (“YES” in STEP 4), as shown in FIG. 9A(a), a message informing that an error has occurred is firstly displayed on the operation display unit 112 (STEP 21). To be specific, information informing that 500-yen coin is insufficient is displayed on the operation display unit 112, and a message of “put insufficient coin” is displayed on the operation display unit 112. Then, when a 500-yen coin has been replenished by the operator into the coin change machine 100 (“YES” in STEP 22), as shown in FIG. 9A(b), a message of “replenishing” and the number of replenished 500-yen coin(s) are displayed on the operation display unit 112 (STEP 23). Even when only one 500-yen coin is replenished into the coin change machine 100 while the storage-empty reset experience mode is in execution, the empty state or the near-empty state is reset in the coin change machine 100. When the empty state or the near-empty state has been reset in the coin change machine 100 (“YES” in STEP 24), the judgment unit 154 judges that the malfunction is reset (STEP 25). Then, as shown in FIG. 9A(c), a message of “reset completed” is displayed on the operation display unit 112.

Thereafter, the coin, which has been put into the coin change machine 100 in order to reset the error relating to the storage empty, is dispensed from the coin change machine 100 (STEP 26). At this time, as shown in FIG. 9B(d), a message of “dispensing reset money” is displayed on the operation display unit 112. Then, when the coin has been dispensed from the coin change machine 100, as shown in FIG. 9B(e), a message of “pull out reset money” is displayed on the operation display unit 112. After that, when the operator has pulled out the dispensed coin from the coin change machine 100 (STEP 27), the storage-empty reset experience mode is completed.

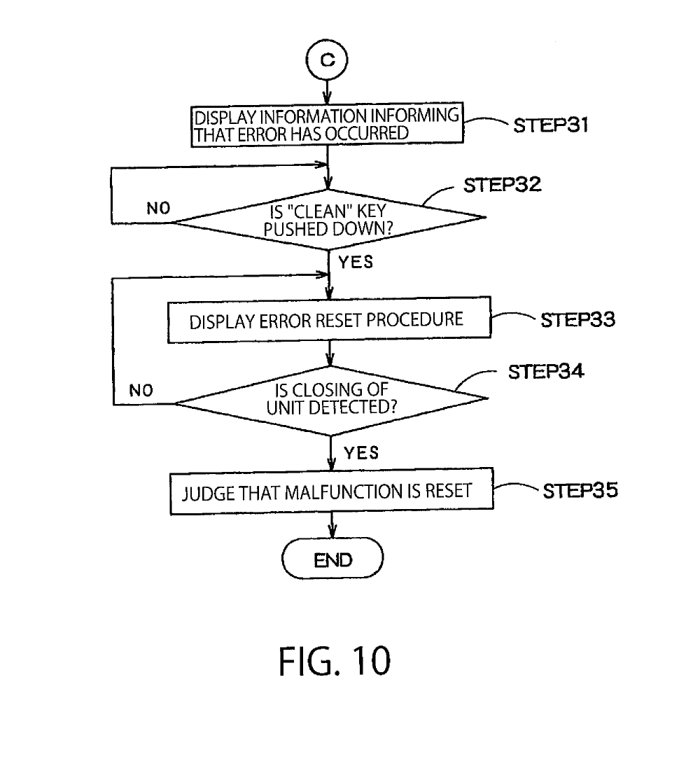

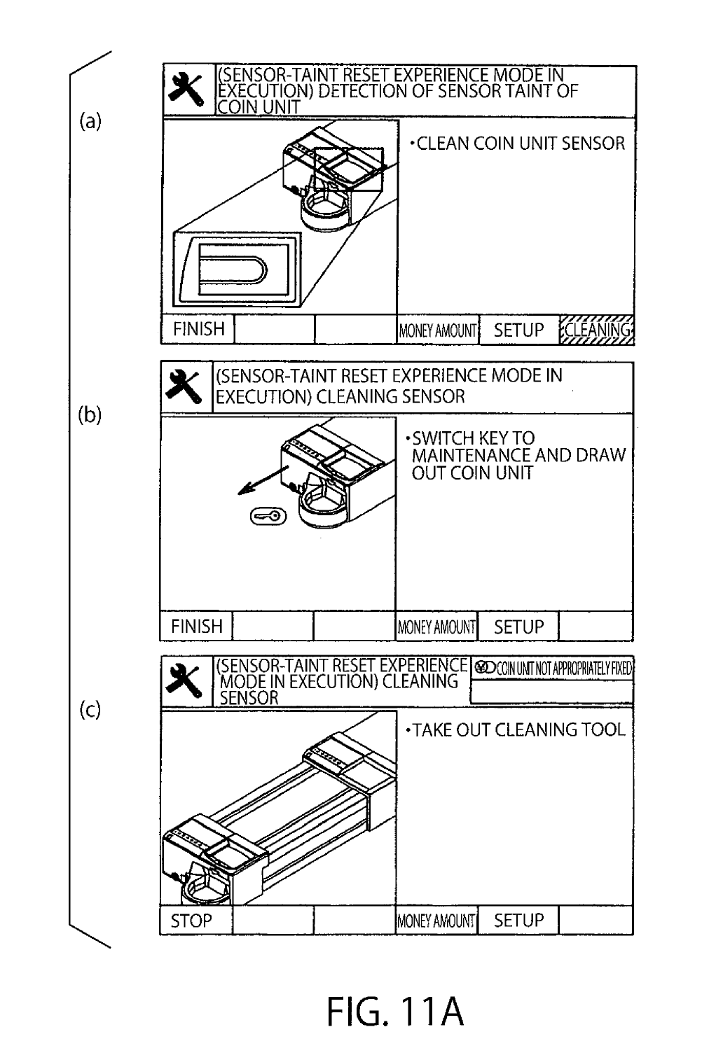

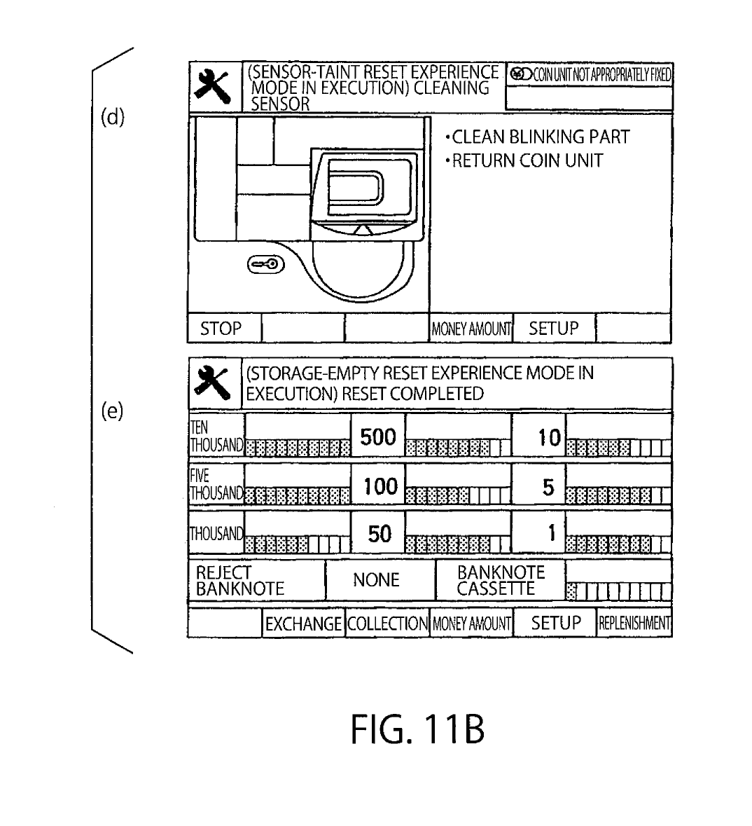

Next, there is described an operation that is performed when the sensor-taint reset experience mode is in execution by the control unit 130 of the coin change machine 100 and the control unit 230 of the banknote change machine 200, with reference to the flowchart shown in FIG. 10 and the display screen of the operation display unit 112 of the coin change machine 100 shown in FIGS. 11A and 11B.

While the experience item selection screen of the error reset experience mode shown in FIG. 5(c) is displayed on the operation display unit 112, when the sensor-taint reset experience mode is selected by the selection unit 150 (“YES” in STEP 5), as shown in FIG. 11A(a), a message informing that an error has occurred is firstly displayed on the operation display unit 112 (STEP 31). To be specific, messages of “coin-unit sensor taint is detected” and “clean up coin-unit sensor” are displayed on the operation display unit 112, and an image of a part to be cleaned is displayed on the operation display unit 112. A “clean” key is highlighted on the operation display unit 112.

When the operator has pushed down the “clean” key (“YES” in step 32), an error reset procedure is displayed on the operation display unit 112 (STEP 33). To be specific, as shown in FIG. 11A(b), a message of “switch key to maintenance and draw out coin unit” is firstly displayed on the operation display unit 112. Then, the operator draws the coin unit (unit provided with the respective coin storing units 106) of the coin change machine 100 from the housing 110 so that opening of the unit is detected. Then, as shown in FIG. 11A(c), the coin unit of the coin change machine 100 drawn from the housing 110 is displayed on the operation display unit 112, and a message of “take out cleaning tool” is displayed. Thereafter, as shown in FIG. 11B(d), an image of the part to be cleaned is displayed in a blinking fashion on the operation display unit 112, and messages of “clean blinking part” and “return coin unit” are displayed on the operation display unit 112.

Then, the sensor is cleaned by the operator and the coin unit of the coin change machine 100 is returned into the housing 110 so that closing of the unit is detected (“YES” in STEP 34). Thus, the judgment unit judges that the malfunction is reset (STEP 35). In this manner, the sensor-taint reset experience mode is completed.

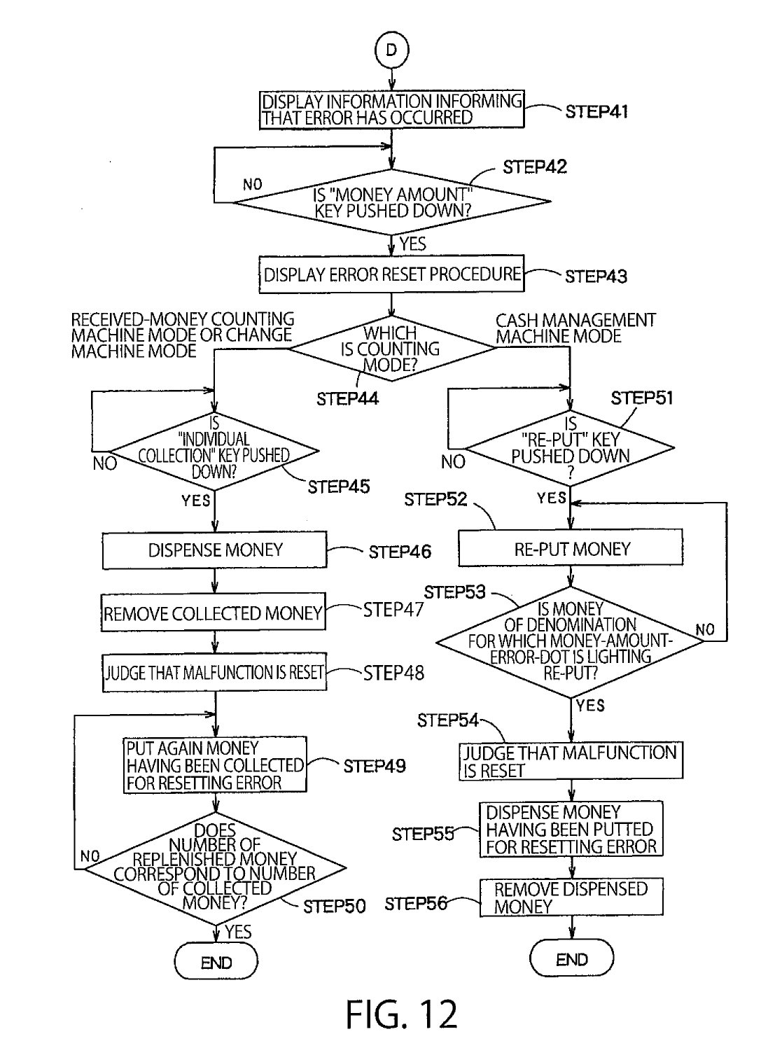

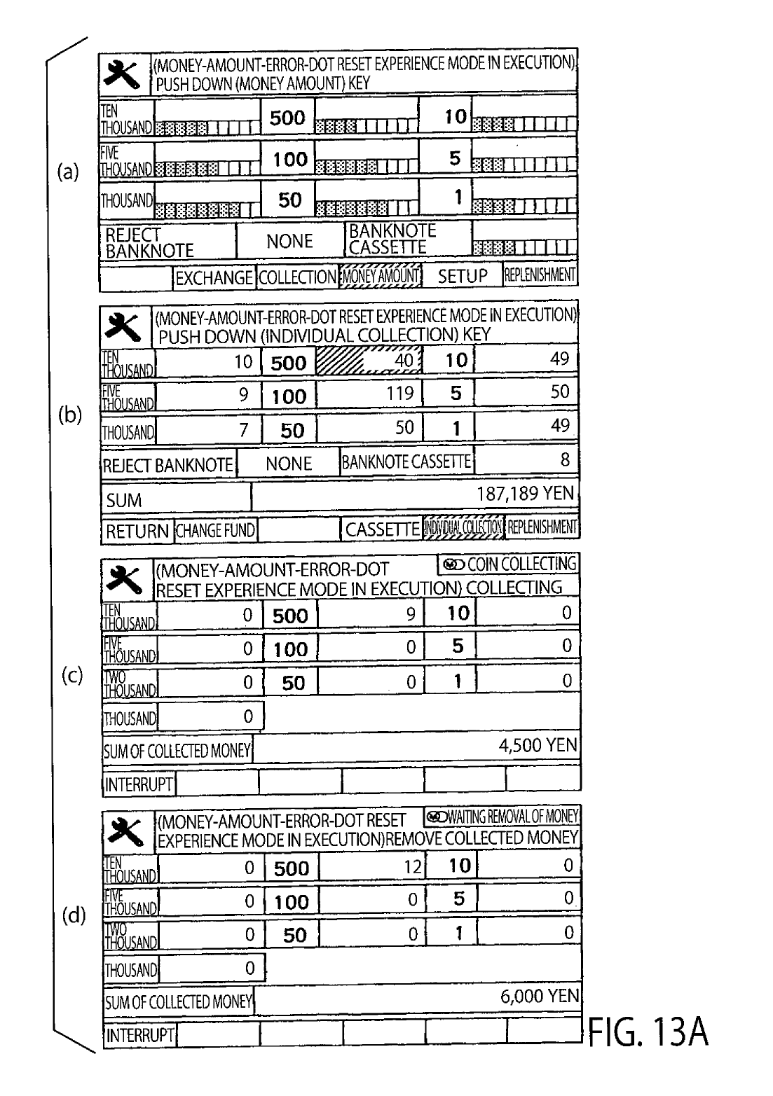

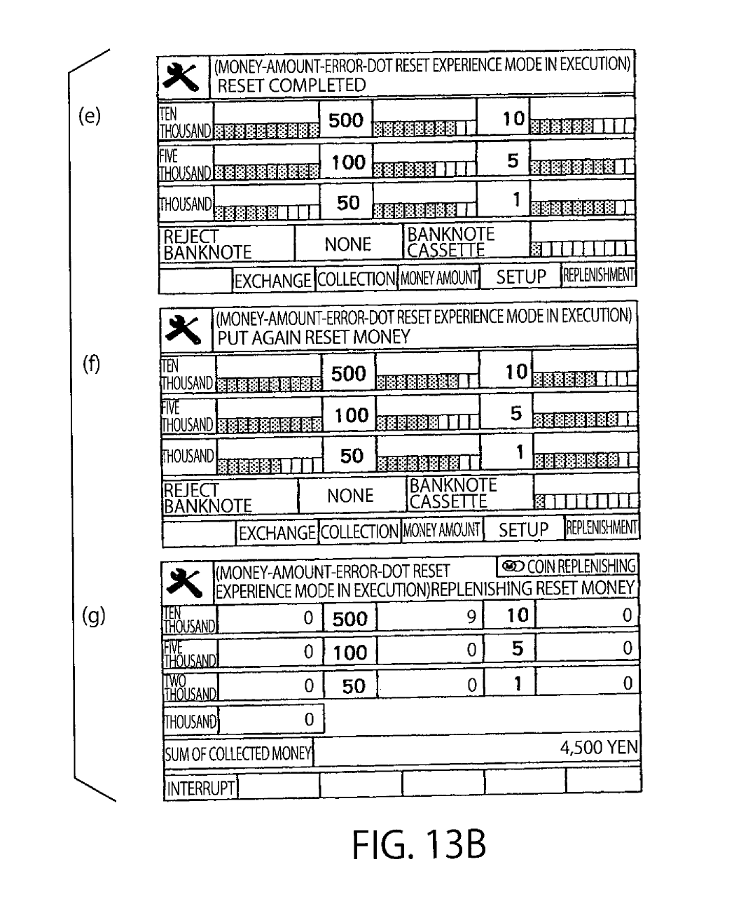

Next, there is described an operation that is performed when the money-amount-error-dot reset experience mode is in execution by the control unit 130 of the coin change machine 100 and the control unit 230 of the banknote change machine 200, with reference to the flowchart shown in FIG. 12 and the the display screen of the operation display unit 112 of the coin change machine 100 shown in FIGS. 13A and 13B.

While the experience item selection screen of the error reset experience mode shown in FIG. 5(c) is displayed on the operation display unit 112, when the money-amount-error-dot reset experience mode is selected by the selection unit 150 (“YES” in STEP 6), as shown in FIG. 13A(a), a message informing that an error has occurred is firstly displayed on the operation display unit 112 (STEP 41). To be specific, a message of “push down money amount key” is displayed on the operation display unit 112. At this time, the “money amount” key is highlighted on the operation display unit 112. Then, when the operator has pushed down the “money amount” key (“YES” in STEP 42), an error reset procedure is displayed on the operation display unit 112 (STEP 43). The error reset procedure differs depending on a counting mode of the coin change machine 100 and the banknote change machine 200.

For example, there are three modes as the counting mode of the coin change machine 100 and the banknote change machine 200. Namely, there are a received-money counting machine mode, a change machine mode and a cash management machine mode. The received-money counting machine mode is a mode in which the coin change machine 100 and the banknote change machine 200 have a received-money counting function and a change dispensing function. When such a received-money counting machine mode is in execution, an operation procedure in a register is as follows. Namely, a sum of an article(s) is calculated by the control terminal machine 300 formed of a POS register. Then, a clerk puts money received from a client into the coin change machine 100 and the banknote change machine 200. Thereafter, change is dispensed from the coin change machine 100 and the banknote change machine 200.

In addition, the change machine mode is a mode in which the coin change machine 100 and the banknote change machine 200 have only the change dispensing function. When the change machine mode is in execution, an operation procedure in the register is as follows. Namely, a sum of an article(s) is calculated by the control terminal machine 300 formed of a POS register. Then, a clerk manually inputs a sum of money received from a client to the control terminal machine 300. Thereafter, change is dispensed from the coin change machine 100 and the banknote change machine 200. Thereafter, a coin and a banknote are replenished into the coin change machine 100 and the banknote change machine 200 at a given timing.

In addition, the cash management machine mode is a mode in which the coin change machine 100 and the banknote change machine 200 have a received-money counting function and a change dispensing function, similarly to the received-money counting machine mode. When such a cash management machine mode is in execution, an operation procedure in the register is as follows. Namely, similarly to the received-money counting machine mode, a sum of an article(s) is calculated by the control terminal machine 300 formed of a POS register. Then, a clerk puts money received from a client into the coin change machine 100 and the banknote change machine 200. Thereafter, change is dispensed from the coin change machine 100 and the banknote change machine 200.

A timing at which a money amount upon a dispensing operation is updated is described. When the received-money counting mode or the change machine mode is in execution, a money amount is updated at a timing when one coin or one banknote is fed out from the coin storing units 106 of the coin change machine 100 or the banknote storing units 206 of the banknote change machine 200. On the other hand, when the cash management machine mode is in execution, a money amount is updated at a timing when a coin(s) or a banknote(s) to be dispensed based on an instruction are all discharged outside machine bodies of the coin change machine 100 or the banknote change machine 200. Thus, in the received-money counting mode and the change machine mode, when an error occurs in the coin change machine 100 and the banknote change machine 200 during a dispensing operation, a coin in the dispensing and transporting unit 108 of the coin change machine 100 and a banknote in the rotary transporting unit 203a of the banknote change machine 200 should be returned to the coin storing units 106 and the banknote storing units 206, or be sent outside the machine bodies of the change machines. The operator will be at a loss to judge which is suitable. On the other hand, in the cash management machine mode, when an error occurs in the coin change machine 100 and the banknote change machine 200 during a dispensing operation, a coin and a banknote in the coin change machine 100 and the banknote change machine 200 can be all returned to the coin storing units 106 and the banknote storing units 206 without any problem.

In a case where the counting mode is the received-money counting machine mode or the change machine mode (STEP 44), when an error reset procedure is displayed on the operation display unit 112 (STEP 43), as shown in FIG. 13A(b), a message of “push down individual collection key” is displayed on the operation display unit 112, and the “individual collection” key is highlighted on the operation display unit 112. When the operator has pushed down the “individual collection” key (“YES” in STEP 45), a dispensing operation is performed in the coin change machine 100 and the banknote change machine 200 (STEP 46). At this time, as shown in FIG. 13A(c), a message of “collecting” is displayed on the operation display unit 112. Then, when the dispensing operation has completed in the coin change machine 100 and the banknote change machine 200, as shown in FIG. 13A(d), a message of “pull out collected money” is displayed on the operation display unit 112. Thereafter, when the operator has pulled out the collected coin (STEP 47), the judgment unit 154 judges that the malfunction is reset (STEP 48). Then, as shown in FIG. 13B(e), a message of “reset completed” is displayed on the operation display unit 112.

Following thereto, as shown in FIG. 13B(f), a message of “put reset money again” is displayed on the operation display unit 112. Then, when the operator has put again the coin and the banknote collected from the coin change machine 100 and the banknote change machine 200, into the coin change machine 100 and the banknote change machine 200 (STEP 49), as shown in FIG. 13B(g), a message of “replenishing reset money” is displayed on the operation display unit 112. Then, the coin and the banknote collected from the coin change machine 100 and the banknote change machine 200 are replenished into the coin change machine 100 and the banknote change machine 200 (“YES” in STEP 50), so that the money-amount-error-dot reset experience mode is completed.

In a case where the counting mode is the cash management machine mode (STEP 44), when an error reset procedure is displayed on the operation display unit 112 (STEP 43), a message of “push down re-put key”, instead of the message of “push down individual collection key” shown in FIG. 13A(b), is displayed on the operation display unit 112. At this time, the “re-put” key is highlighted on the operation display unit 112. Although the “re-put” key is not shown in FIGS. 13A and 13B, the “re-put” key is actually displayed in place of the “individual collection” key shown in FIG. 13A(b). When the operator has pushed down the “re-put” key (“YES” in STEP 51) and a coin and a banknote have been put into the coin change machine 100 and the banknote change machine 200, a coin re-putting operation and a banknote re-putting operation are performed in the coin change machine 100 and the banknote change machine 200 (STEP 52). At this time, a message of “re-putting” is displayed on the operation display unit 112. Then, a coin(s) and a banknote(s) whose denomination having a money-amount-error-dot, the numbers of which are regarded to be insufficient by the operator, are re-put into the coin change machine 100 and the banknote change machine 200.

When the coin(s) and the banknote(s) whose denomination having the money-amount-error-dot have been re-put into the coin change machine 100 and the banknote change machine 200 (“YES” in STEP 53), the judgment unit 154 judges that the malfunction is reset (STEP 54). Then, as shown in FIG. 13B(e), a message of “reset completed” is displayed on the operation display unit 112.

Thereafter, the coin(s) and the banknote(s), which have been re-put into the coin change machine 100 and the banknote change machine 200 in order to reset the error relating to the money-amount-error-dot, are dispensed from the coin change machine 100 and the banknote change machine 200 (STEP 55). At this time, a message of “dispensing reset money” is displayed on the operation display unit 112. Then, when the coin(s) and the banknote(s) have been dispensed from the coin change machine 100 and the banknote change machine 200, a message of “pull out reset money” is displayed on the operation display unit 112. After that, when the operator has pulled out the coin(s) and the banknote(s) having been dispensed from the coin change machine 100 and the banknote change machine 200 STEP 56), the money-amount-error-dot reset experience mode is completed.

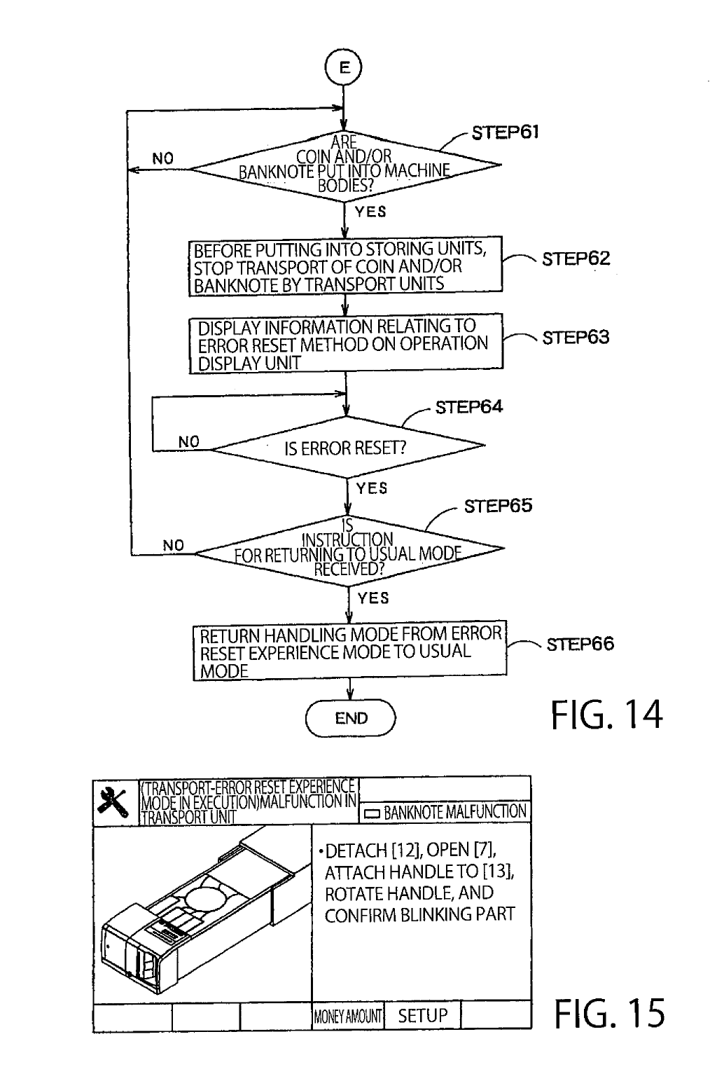

Next, there is described an operation that is performed when the transport-error reset experience mode is in execution by the control unit 130 of the coin change machine 100 and the control unit 230 of the banknote change machine 200, with reference to the flowchart shown in FIG. 14 and the display screen of the operation display unit 112 of the coin change machine shown in FIG. 15.

While the experience item selection screen of the error reset experience mode shown in FIG. 5(c) is displayed on the operation display unit 112, when the transport-error reset experience mode is selected by the selection unit 150 (“YES” in STEP 7), a message instructing that an operator puts a coin and a banknote into the machine bodies of the coin change machine 100 and the banknote change machine 200 is displayed on the operation display unit 112. Then, a coin and a banknote are put into the machine bodies of the coin change machine 100 and the banknote change machine 200 (“YES” in STEP 61). After the coin and the banknote have been taken into the machine bodies and before the coin and the banknote are transported to the coin storing units 106 and the banknote storing units 206, the coin and the banknote are stopped in the course of transportation (STEP 62). In more detail, while the transport-error reset experience mode is in execution, when a coin is received in the coin receiving unit 114 of the coin change machine 100, the coin is transported by the depositing and transporting unit 103 and recognized by the coin recognition unit 101. After that, at a position just before the diversion unit 104, the transport of the coin by the depositing and transporting unit 103 is stopped. To be more specific, as shown in FIG. 1, a detection sensor 105 is located on a position just before the diversion unit 104 in the depositing and transporting unit 103. When the coin is detected by the detection sensor 105, the transport of the coin by the depositing and transporting unit 103 is stopped. On the other hand, while the transport-error reset experience mode is in execution, when a banknote is inserted to the banknote inlet 214a of the banknote receiving unit 214, at a time point when the banknote is transported by the rotary transporting unit 203a and recognized by the banknote recognition unit 201, the transport of the banknote by the rotary transporting unit 203a is stopped. By stopping the coin and the banknote by the depositing and transporting unit 103 and the rotary transporting unit 203a in the course of transportation, a pseudo-jam condition can be artificially generated. When the transport-error reset experience mode is in execution, the coin and the banknote recognized by the coin recognition unit 101 and the banknote recognition unit 201 are not included in a count result.

When the transport-error reset experience mode is in execution, the control unit 130 and the control unit 230 stop the coin and the banknote in the course of transportation by the depositing and transporting unit 103 of the coin change machine 100 and the rotary transporting unit 203a of the banknote change machine 200, and then output information relating to an error reset method corresponding to the generated error. The outputted information relating to the error reset method is displayed on the operation display unit 112 of the coin change machine 100 (STEP 63). Specifically, after the banknote has been stopped in the course of transportation by the rotary transporting unit 203a of the banknote change machine 200, information relating to the error reset method as shown in FIG. 15 is displayed on the operation display unit 112. More specifically, an image of a part to be operated for resetting the error and a restoration operation procedure are displayed on the operation display unit 112.

Then, by operating respective parts in accordance with the error reset method displayed on the operation display unit 112, the operator can take the coin and the banknote, which have been stopped in the course transportation, from the coin change machine 100 and the banknote change machine 200, whereby the error is reset (“YES” in STEP 64). After the error has been reset so that the machines are returned to the original states, the operator performs a predetermined returning operation through the operation display unit 112 (specifically the operator pushes down the “return” key displayed on the operation display unit 112) (“YES” in STEP 65). Thus, the handling mode to be executed in the control unit 130 and the control unit 230 is returned from the transport-error reset experience mode to the usual mode (STEP 66). When the returning operation is not performed (“NO” in STEP 65), another error is generated by again putting a coin or a banknote, so that the operator can experience the error reset operation again. As an alternative example, the number of error reset experience may be limited to one. In this case, the handling mode to be executed in the control unit 130 and the control unit 230 may be returned automatically from the transport-error reset experience mode to the usual mode, without the predetermined returning operation to be performed by an operator through the operation display unit 112. In this manner, the transport-error reset experience mode is completed.

In this embodiment, the error reset method displayed on the operation display unit 112 when one of the above various error reset experience modes is in execution differs from the error reset method displayed on the operation display unit 112 when the usual mode is in execution. To be specific, when the error reset experience mode is in execution, a message such as [storage-full reset experience mode in execution] or [storage-empty reset experience mode in execution] is displayed on an upper left column of the screen of the operation display unit 112. Alternatively, the error reset method displayed on the operation display unit 112 when the error reset experience mode is in execution may be displayed in a different color from that of the error reset method displayed on the operation display unit 112 when the usual mode is in execution.

As described above, according to the coin change machine 100 and the banknote change machine 200 in this embodiment, or the money handling system 1 including the coin change machine 100 and the banknote change machine 200, at least the error reset experience mode can be selected by the selection unit 150. When the error reset experience mode has been selected by the selection unit 150, information informing that a malfunction has occurred can be outputted by the output unit 152. Namely, by selecting the error reset experience mode by the selection unit 150, it is possible to cause an operator to experience in advance an error reset operation (restoration operation) outside office hours or the like. As a result, even when a malfunction has actually been generated in the coin change machine 100 and the banknote change machine 200, the coin change machine 100 and the banknote change machine 200 can be promptly restored regardless of a skill level of an operator.

In addition, according to the coin change machine 100 and the banknote change machine 200 in this embodiment, or the money handling system 1 including the coin change machine 100 and the banknote change machine 200, when the transport-error reset experience mode has been selected by the selection unit 150, the control unit 130 and the control unit 230 are configured to stop a coin in the course of transportation by the depositing and transporting unit 103 and/or a banknote in the course of transportation by the rotary transport unit 203a. Namely, when the transport-error reset experience mode is in execution, since a banknote and a coin in the machine bodies of the coin change machine 100 and the banknote change machine 200 are stopped in the course of transportation, a jam can be artificially generated.

In addition, in the coin change machine 100 and the banknote change machine 200 in this embodiment, when the error reset experience mode has been selected by the selection unit 150, the output unit 152 is configured to additionally output, in addition to the information informing that a malfunction has occurred, information relating to a malfunction reset method. Thus, when an operator is caused to experience in advance an error reset operation outside office hours or the like, the operator can perform the error reset operation with reference to the outputted malfunction reset method.

In addition, in the coin change machine 100 and the banknote change machine 200 in this embodiment, when the coin handling machine 100 and the banknote change machine 200 have been operated in accordance with the malfunction reset method outputted by the output unit 152, the judgment unit 154 is configured to judge that the malfunction is reset. Thus, when an operator is caused to experience in advance an error reset operation outside office hours or the like, whether the error is reset or not can be reliably judged by the judgment unit 154.

In addition, in the coin change machine 100 and the banknote change machine 200 in this embodiment, the information outputted by the output unit 152 is displayed on the operation display unit 112. At this time, the operation display unit 112 is configured to display the contents to be displayed when the error reset experience mode has been selected by the selection unit 150, and the contents to be displayed when a mode other than the error reset experience mode, specifically, the usual mode is selected by the selection unit 150, in different manners from each other. For example, when the error reset experience mode is in execution, a message such as [storage-full reset experience mode in execution] or [storage-empty reset experience mode in execution] is displayed on an upper left column of the screen of the operation display unit 112. Alternatively, the error reset method displayed on the operation display unit 112 when the error reset experience mode is in execution may be displayed in a different color from that of the error reset method displayed on the operation display unit 112 when the usual mode is in execution.

In addition, in the coin change machine 100 and the banknote change machine 200 in this embodiment, the information outputted by the output unit 152 is transmitted to an external apparatus (such as the control terminal machine 300 and the host server 400) through the interfaces 132 and 232. Thus, an operator can perform an error reset operation (restoration operation) while looking at an error reset method displayed on the display unit 302 of the control terminal machine 300, for example.

In addition, in the coin change machine 100 and the banknote change machine 200 in this embodiment, the plural types of error reset experience modes are prepared in advance. When one error reset experience mode has been selected by the selection unit 150, which type of the error reset experience mode is to be executed is also selected.

In addition, in the coin change machine 100 and the banknote change machine 200 in this embodiment, when the transport-error reset experience mode is in execution, the control unit 130 and the control unit 230 respectively control the depositing and transporting unit 103 and the rotary transporting unit 203a such that a banknote and a coin, which have been put into the machine bodies of the coin change machine 100 and the banknote change machine 200 through the coin receiving unit 114 and the banknote receiving unit 214, are stopped in the course of transportation by the depositing and transporting unit 103 and the rotary transporting unit 203a. Thus, it can be prevented that, when the transport-error reset experience mode is in execution, the banknote and the coin, which have been deposited into the machine bodies of the coin change machine 100 and the banknote change machine 200, are stored into the coin storing units 106 and the banknote storing units 206. Therefore, it is possible to prevent that the money amounts of the coins and the banknotes stored inside the coin change machine 100 and the banknote change machine 200 are changed.

The coin change machine 100 and the banknote change machine 200 in this embodiment are not limited to the aforementioned embodiment, but can be variously modified.

For example, the selection unit 150 that is capable of selecting at least the error reset experience mode, the output unit 152 that outputs information informing that a malfunction has occurred when the error reset experience mode has been selected by the selection unit 150, and the judgment unit 154 that judges that a malfunction is reset, may not be necessarily provided on the coin change machine 100. One, some or all of these units may not be provided on the coin change machine 100 and the banknote change machine 200, but may be provided on an external apparatus that is connected for communication with the coin change machine 100 and the banknote change machine 200. For example, one, some or all of selection unit 150, the output unit 152 and the judgment unit 154 may be provided on the control terminal machine 300. In this case, the information outputted by the output unit 152 may be displayed on the display unit 302 of the control terminal machine 300.

In addition, after the transport-error reset experience mode has been selected by the selection unit 150, a coin and a banknote may be automatically fed out from the coin storing units 106 and the banknote storing units 206 to the depositing and transporting unit 108 and the rotary transporting unit 203a, without a coin and a banknote being put into the machine bodies of the coin change machine 100 and the banknote change machine 200 by an operator. In this case, before the coin and the banknote having been fed out from the coin storing units 106 and the banknote storing units 206 are respectively transported to the coin discharging unit 116 and the banknote discharging unit 216, the coin and the banknote are stopped in the course of transportation by the dispensing and transporting unit 108 and the rotary transporting unit 203a. In more detail, while the transport-error reset experience mode is in execution, when a coin is automatically fed out from the coin storing units 106 of the coin change machine 100, the coin is transported by the dispensing and transporting unit 108 toward the coin discharging unit 116. The transport of the coin by the dispensing and transporting unit 108 is stopped at a position just before the coin discharging unit 116. On the other hand, while the transport-error reset experience mode is in execution, when a banknote is automatically fed out from the banknote storing units 206 of the banknote change machine 200, the transport of the banknote by the rotary transporting unit 203a is stopped at a time point when the banknote is transported by the rotary transporting unit 203a and is recognized by the banknote recognition unit 201. In this manner, by stopping a coin and a banknote in the course of transportation by the dispensing and transporting unit 108 and the rotary transporting unit 203a, it is possible to artificially generate a pseudo-jam condition of a coin and a banknote having been fed out from the coin storing units 106 and the banknote storing units 206.

After a coin and a banknote have been stopped in the course of transportation by the dispensing and transporting unit 108 of the coin change machine 100 and the rotary transporting unit 203a of the banknote change machine 200, the control unit 130 of the coin change machine 100 and the control unit 230 of the banknote change machine 200 output information relating to an error reset method. The outputted information relating to the error reset method is displayed on the operation display unit 112 of the coin change machine 100.

Thereafter, an operator takes out the coin and the banknote, which have been stopped in the course of transportation, from the machine bodies of the coin change machine 100 and the banknote change machine 200 in accordance with the error reset method displayed on the operation display unit 112, whereby the error is reset. After the error has been reset, the operator performs a predetermined returning operation through the operation display unit 112, so that the handling mode to be executed in the control unit 130 and the control unit 230 returns from the transport-error experience mode to the usual mode. Following thereto, the operation display unit 112 displays an instruction for putting in again the coin and the banknote having been taken out from the machine bodies of the coin change machine 100 and the banknote change machine 200.

Based on the contents displayed on the operation display unit 112, the operator puts in again the coin and the banknote having been taken out from the machine bodies of the coin change machine 100 and the banknote change machine 200. Thus, the coin and the banknote having been put again into the machine bodies of the coin change machine 100 and the banknote change machine 200 are stored again into the coin storing units 106 and the banknote storing units 206. Thus, it can be prevented that the money amounts of the coins and the banknotes stored inside the coin change machine 100 and the banknote change machine 200 are changed, before and after the execution of the transport-error reset experience mode.

According to the coin change machine 100 and the banknote change machine 200 in the modification example, when the transport-error reset experience mode is in execution, the control unit 130 and the control unit 230 respectively control the dispensing and transporting unit 108 and the rotary transporting unit 203a such that a coin and a banknote, which are to be dispensed outside the machine bodies of the coin change machine 100 and the banknote change machine 200 through the coin discharging unit 116 and the banknote discharging unit 216, are stopped in the course of transportation by the dispensing and transporting unit 108 and the rotary transporting unit 203a. Also in this case, by selecting the transport-error reset experience mode by the selection unit 150, it is possible to cause an operator to experience in advance an error reset operation (restoration operation) outside office hours or the like. The modification example is advantageous in that it is not necessary to prepare a banknote and a coin for experiencing an error reset operation, and that an error generated in a coin dispensing and transporting path and a banknote dispensing and transporting path can be experienced.

In the coin change machine 100 and the banknote change machine 200 in the aforementioned modification example, while the transport-error reset experience mode is in execution, information relating to a coin and a banknote which have been stopped in the course of transportation by the dispensing and transporting unit 108 and the rotary transporting unit 203a, and information relating to a coin and a banknote which have been put again into the machine bodies of the coin change machine 100 and the banknote change machine 200, are compared to each other. When the former information and the latter information conform to each other, the handling mode can be returned to the usual mode. Otherwise, an alert is issued. Thus, when the transport-error reset experience mode is in execution, it can be confirmed whether a coin and a banknote having been taken out from the machine bodies of the coin change machine 100 and the banknote change machine 200 are properly put again into the machine bodies of the coin change machine 100 and the banknote change machine 200 or not.

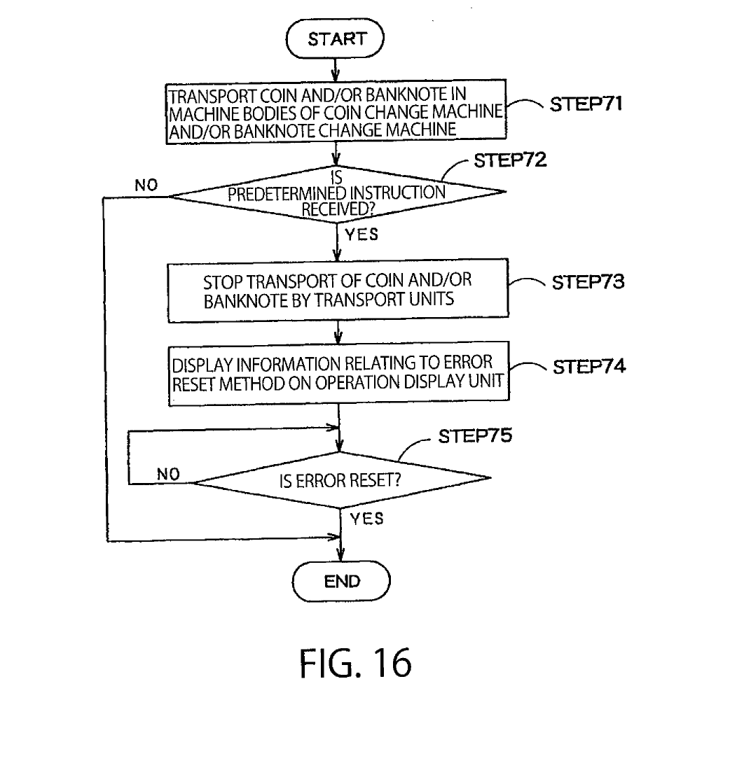

In addition, in the coin change machine 100 and the banknote change machine 200 in this embodiment, the selection unit 150 is not limited to a unit that is capable of selecting the error reset experience mode. As an alternative modification example of the coin change machine 100 and the banknote change machine 200, the control unit 130 and the control unit 230 may be configured to, upon receipt of a predetermined instruction, stop a coin and a banknote in the course of transportation in the machine bodies of the coin change machine 100 and the banknote change machine 200. Such an alternative modification example of the coin change machine 100 and the banknote change machine 200 is described with reference to the flowchart shown in FIG. 16.

According to the coin change machine 100 and the banknote change machine 200 in the alternative modification example, the error reset experience mode is not set in the control unit 130 and the control unit 230. In place thereof, when the control unit 130 and/or the control unit 230 receive a predetermined instruction (“YES” in STEP 72) while a coin and/or a banknote are transported in the machine bodies of the coin change machine 100 and/or the banknote change machine 200 (STEP 71), the coin and/or the banknote are stopped in the course of transportation in the machine bodies of the coin change machine 100 and/or the banknote change machine 200 (STEP 73). To be more specific, when an operator inputs such a predetermined instruction through the operation display unit 112, or when such a predetermined instruction is transmitted from the control terminal machine 300 or the host server 400 to the control unit 130 and/or the control unit 230 of the coin change machine 100 and/or the banknote change machine 200, the predetermined instruction is given to the control unit 130 and/or the control unit 230.

Then, after the coin and/or the banknote have been stopped in the course of transportation in the machine bodies of the coin change machine 100 and/or the banknote change machine 200, the control unit 130 and/or the control unit 230 output information relating to an error reset method. The outputted information relating to the error reset method is displayed on the operation display unit 112 of the coin change machine 100 (STEP 74). Thereafter, by operating respective parts in accordance with the error reset method displayed on the operation display unit 112, the operator takes out the coin and/or the banknote, which have been stopped in the course of transportation, from the machine bodies of the coin change machine 100 and/or the banknote change machine 200 to return the apparatus to the original state, whereby the error is reset (“YES” in STEP 75).

As described above, in the alternative modification example of the coin change machine 100 and the banknote change machine 200, the control unit 130 and the control unit 230 are configured to, upon receipt of a predetermined instruction, control the depositing and transporting unit 103, the dispensing and transporting unit 108, the rotary transporting unit 203a and so on, such that a coin and/or a banknote are stopped in the course of transportation by the depositing and transporting unit 103, the dispensing and transporting unit 108, the rotary transporting unit 203a and so on. By giving such a predetermined instruction to the control unit 130 and/or the control unit 230 so that a coin and/or a banknote are stopped in the housings in the course of transportation, a pseudo-jam condition can be artificially generated. Thus, it is possible to cause an operator to experience in advance an error reset operation (restoration operation) outside office hours or the like. As a result, even when a malfunction such as a jam actually occurs in the coin change machine 100 and/or the banknote change machine 200, an operator of any skill can promptly restore the coin change machine 100 and/or the banknote change machine 200, due to his/her previous experience of the error reset operation (restoration operation).

In addition, the money handling apparatus used in the present invention is not limited to the coin change machine and the banknote change machine. As long as an apparatus can handle money composed of a coin(s) and a banknote(s), an apparatus other than the coin change machine and the banknote change machine may be applied as the money handling apparatus used in the present invention.

In addition, while the transport-error reset experience mode is in execution, when a clearance instruction is inputted by an operator through the operation display unit 112 during a pseudo-jam generated in the coin change machine 100 and/or the banknote change machine 200, transport units such as the depositing and transporting unit 103, the dispensing and transporting unit 108, the rotary transporting unit 203a and so on may be driven in such a manner that a stopped coin and/or a stopped banknote are transported to the coin discharging unit 116 and/or the banknote discharging unit 216. In this case, when the transport-error reset experience mode should be suspended because an error reset operation cannot be properly performed, a coin and/or a banknote having been put into the coin change machine 100 and/or the banknote change machine 200 can be returned to the outside of the machine bodies.

In addition, while the transport-error reset experience mode is in execution, when a pseudo-jam is generated in the coin change machine 100 and/or the banknote change machine 200, an operator may specify positions at which a coin and/or a banknote are to be stopped, through the operation display unit 112. When an operator puts a coin and/or a banknote into the machine bodies of the coin change machine 100 and/or the banknote change machine 200 after the operator has specified positions at which a coin and/or a banknote are to be stopped through the operation display unit 112, the coin and/or the banknote are stopped at the specified positions, so that the operator can experience an error reset operation for these positions. For example, in the coin change machine 100, it is possible to select a position at which a coin is to be stopped, among the coin receiving unit 114, the coin recognition unit 101, a position on the upstream side of the diversion unit 104 in the depositing and transporting unit 103, the diversion unit 104, a position on the downstream side of the diversion unit 104 in the depositing and transporting unit 103, and the coin discharging unit 116.

In addition, there may be provided in which, while the transport-error reset experience mode is in execution, an error is generated by stopping a coin and/or a banknote at a random position(s) so that a pseudo-jam is generated in the coin change machine 100 and/or the banknote change machine 200. By executing such a mode, it is possible to test an ability of an operator for resetting an error, or to improve an operator's skill.

1. A money handling apparatus configured to handle money, comprising:
a selection unit capable of selecting at least an error reset experience mode; and
an output unit configured to output information informing that a malfunction has occurred, when the error reset experience mode has been selected by the selection unit.

2. The money handling apparatus according to claim 1, wherein
the output unit is configured to additionally output, when the error reset experience mode has been selected by the selection unit, information relating to a malfunction reset method, in addition to the information informing that a malfunction has occurred.

3. The money handling apparatus according to claim 2 further comprising a judgment unit configured to judge that the malfunction is reset, when the money handling apparatus has been operated in accordance with the information relating to the malfunction reset method outputted by the output unit.

4. The money handling apparatus according to claim 1, wherein:
the money handling apparatus further comprises a display unit; and
the information outputted by the output unit is displayed on the display unit.

5. The money handling apparatus according to claim 4, wherein
the display unit is configured to display contents to be displayed when the error reset experience mode has been selected by the selection unit, and contents to be displayed when a mode other than the error reset experience mode has been selected by the selection unit, in different manners from each other.

6. The money handling apparatus according to claim 1, wherein:
the money handling apparatus further comprises a communication unit; and
the information outputted by the output unit is transmitted by the communication unit to an external apparatus provided separately from the money handling apparatus.

7. The money handling apparatus according to claim 1 further comprising:
a transport unit configured to transport money; and
a control unit configured to control the transport unit such that the money is stopped in a course of transportation by the transport unit, when the error reset experience mode has been selected by the selection unit.

8. The money handling apparatus according to claim 1, wherein:
plural types of the error reset experience modes are prepared in advance; and
when the error reset experience mode has been selected by the selection unit, which type of the error experience mode is to be executed is also decided.

9. The money handling apparatus according to claim 8, wherein
the plural types of error reset experience modes are a part or all of a group including a storage-full reset experience mode, a storage-empty reset experience mode, a sensor-taint reset experience mode, a possible money-amount-error reset experience mode, and a transport-error reset experience mode.

10. A money handling system comprising:
a money handling apparatus configured to handle money;
an external apparatus provided separately from the money handling apparatus and connected for communication with the money handling apparatus;
wherein the money handling system includes:
a selection unit capable of selecting at least an error reset experience mode; and
an output unit configured to output information informing that a malfunction has occurred, when the error reset experience mode has been selected by the selection unit.

11. The money handling system according to claim 10, wherein
the external apparatus includes a display unit; and
the information outputted by the output unit is displayed on the display unit.

12. A money handling method for handling money by means of a money handling apparatus, the money handling method comprising:
selecting an error reset experience mode; and
outputting information informing that a malfunction has occurred, when the error reset experience mode has been selected.
